(19) United States
(12) Patent Application Publication
(10) Pub. No.: US 2024/0040636 A1
(43) Pub. Date: Feb. 1, 2024

(54) METHODS AND ARRANGEMENTS FOR PRIORITY COMMUNICATIONS

(71) Applicant: Intel Corporation, Santa Clara, CA (US)

(72) Inventors: Laurent Cariou, Milizac (FR); Thomas J. Kenney, Portland, OR (US)

(73) Assignee: Intel Corporation, Santa Clara, CA (US)

(21) Appl. No.: 18/377,733

(22) Filed: Oct. 6, 2023

(51) Int. Cl. H04W 74/08; H04W 52/02

(52) U.S. Cl. CPC H04W 74/0875; H04W 52/0216

(57) ABSTRACT

Logic to cause transmission of a defer signal in a contention period that is concurrent with a start of a restricted target wake time service period (rTWT SP), the apparatus comprising at least part of a first station (STA), wherein the first STA has an existing agreement with a second STA for the rTWT SP, at least one of the first STA and the second STA to comprise data associated with a predictable latency access category (AC_PL) of an enhanced distributed channel access (EDCA) mechanism. Logic to contend for access to a medium for transmission of the data during the contention window. Logic to start the contention period, in some embodiments, a margin time prior to the start of the rTWT SP, wherein the rTWT is trigger-enabled or non-trigger enabled, wherein the existing agreement may identify a mode of a trigger-enabled rTWT SP as a first mode or second mode.

### TECHNICAL FIELD

This disclosure generally relates to methods and arrangements for wireless communications and, more particularly, to reduce latency of priority communications.

### BACKGROUND

Wireless standards may provide for various mechanisms to support applications with quality of service (QoS) requirements. Four of the mechanisms may include enhanced distributed channel access (EDCA), hybrid coordination function (HCF) controlled channel access (HCCA), service period (SP) access or service period channel access (SPCA), and dynamic allocation. EDCA sets different access categories for traffic to associate the traffic with different access to contention windows or time durations during which stations (STAs) such as AP STAs and non-AP STAs may compete for access to a channel.

With the proliferation of applications accessing wireless media, some priority communications may still experience significant delays.

### BRIEF DESCRIPTION OF THE DRAWINGS

FIG. 1A depicts a system diagram illustrating an embodiment of a network environment for defer logic circuitry, in accordance with one or more example embodiments.

FIG. 1B depicts an embodiment illustrating interactions between stations (STAs) to establish links.

FIG. 1C depicts an embodiment of a system including multiple MLDs.

FIG. 1D illustrates an embodiment of a radio architecture for STAs, such as the wireless interfaces for STAs depicted in FIGS. 1A-C, to implement secure logic circuitry.

FIG. 1E illustrates an embodiment of front-end module (FEM) circuitry of a wireless interface for STAs, such as the STAs in FIGS. 1A-C, to implement secure logic circuitry.

FIG. 1F illustrates an embodiment of radio integrated circuit (IC) circuitry of a wireless interface for STAs, such as the STAs in FIGS. 1A-C, to implement secure logic circuitry.

FIG. 1G illustrates an embodiment of baseband processing circuitry of a wireless interface for STAs, such as the STAs in FIGS. 1A-C, to implement secure logic circuitry.

FIG. 2A depicts an embodiment of transmissions between four stations and an AP.

FIG. 2B depicts an embodiment of a transmission between one station and an AP.

FIG. 2C depicts an embodiment of a resource units.

FIG. 2D depicts an embodiment of a multiple user (MU) physical layer (PHY) protocol data unit (PPDU).

FIG. 2E depicts another embodiment of a MU PPDU comprising a data field for a MAC management frame.

FIG. 2F depicts an embodiment of a physical layer service data unit (PDSU) comprising a MAC management frame such as shown in FIGS. 2G-I.

FIG. 2G depicts an embodiment of EDCA mechanism timing relationships.

FIG. 2H depicts an embodiment of a backoff procedure for a contention period.

FIG. 2I depicts an embodiment of an individual, trigger-enabled TWT operation.

FIG. 2J depicts an embodiment of a timeline 2340 for prioritized access.

FIG. 2K depicts an embodiment of a TWT setup frame.

FIG. 2L depicts an embodiment of a TWT tear down frame.

FIG. 2M depicts an embodiment of a TWT element.

FIG. 2N depicts an embodiment of a control field of a TWT parameters information field.

FIGS. 2O-2P depict embodiments of a PPDU with a MAC management frame that may be transmitted by an AP MLD to a non-AP MLD, or vice vera.

FIG. 3 depicts an embodiment of a wireless communications interface with defer logic circuitry such as the wireless communications interface shown in FIG. 1C.

FIG. 4A depicts an embodiment of a flowchart to implement defer logic circuitry such as the defer logic circuitry discussed in conjunction with FIGS. 1-3.

FIG. 4B depicts another embodiment of a flowchart to implement defer logic circuitry such as the defer logic circuitry discussed in conjunction with FIGS. 1-3.

FIGS. 4C-D depict embodiments of flowcharts to generate and transmit frames and receive and interpret frames for communications between wireless communication devices.

FIG. 5 depicts an embodiment of a functional diagram of a wireless communication device, in accordance with one or more example embodiments of the present disclosure.

FIG. 6 depicts an embodiment of a block diagram of a machine upon which any of one or more techniques may be performed, in accordance with one or more embodiments.

FIGS. 7-8 depict embodiments of a computer-readable storage medium and a computing platform to implement defer logic circuitry.

### DETAILED DESCRIPTION OF EMBODIMENTS

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Embodiments may combine a new restricted target wake time (rTWT or R-TWT) service period (SP) with a new access category for predictable latency (AC_PL) to further reduce worst case latencies for wireless communications traffic between STAs, such as non-AP STAs and AP STAs, for STAs that are members of a rTWT SP. Target wake times (TWTs) allow STAs to manage activity in the basic service set (BSS) by scheduling STAs to operate at different times in order to minimize contention and to reduce the required amount of time that a STA utilizing a power management mode needs to be awake. TWTs can be individual TWTs or broadcast TWTs.

The rTWT SP may be a period of time negotiated using R-TWT setup during which rTWT member STAs prioritize delivery of latency sensitive traffic. A service period is a period of time during which one or more downlink (DL) individually addressed frames are transmitted to a QoS STA and/or one or more transmission opportunities (TxOPs) are granted to the same STA. SPs may be scheduled or unscheduled. A scheduled SP may be an SP that is scheduled by a QoS AP or a personal basic service set (PBSS) control point (PCP). An unscheduled SP may be a period that is started when a QoS STA transmits a trigger frame to the QoS AP.

One or more STAs may implement prioritized access for data of AC_PL queued for transmission via a medium by immediately transmitting a defer signal on the medium at a fixed time (e.g., arbitration interframe space number (AIFSN)=1, a priority interframe space (PIFS), a distributed coordination function (DIFS), or the like) after a contention period begins. Once the defer signal is sent, the STAs that sent the defer signal will be the only STAs that can decrement their backoff counters and contend for a medium.

The goal of that transmission is cause STAs that did not transmit the defer signal to detect the defer signal and determine that the medium is busy via a clear channel assessment (CCA). Such STAs may defer for a duration that depends on the type of the defer signal defined for AC_PL. Another goal is for multiple STAs that have packets queued in their AC_PL queue may concurrently or simultaneously transmit the defer signal. To address this, the defer signal may be defined such that even if multiple STAs transmit this defer signal at the same time, e.g., a 3rd party STA, which receives all the overlapping defer signals, will determine via CCA that the medium is busy so that the 3rd party STA defers and halts the enhanced distributed channel access (EDCA) process.

In some embodiments, AC_PL may have a larger contention window max (CWmax) to tolerate more STAs. In other embodiments, AC_PL may have a single contention window (CW) that may be scaled dynamically through signaling by the AP STA and may be set so that the number of collisions is bounded, e.g., with a small CW. In some embodiments, specific rules may regulate how STAs are allowed or not allowed to use such prioritized access and allowed or not allowed to send defer signals within an EDCA contention period.

Many embodiments may include defer logic circuitry to send or cause transmission of a defer signal prior to and/or during a rTWT SP to cause STAs that are not members of the rTWT SP to detect a busy channel during the rTWT SP via, e.g., a CCA. The CCA may use a physical carrier sense (CS) or a virtual CS to determine is the medium is busy. The physical CS may occur through energy detection via an antenna of a receiver of a STA. The virtual CS mechanism is achieved by distributing reservation information announcing the impending use of the medium. One means of distributing the medium reservation information is the Duration/identifier (ID) field in individually addressed frames. This Duration/ID field may give the time that the medium is reserved, either to the end of the immediately following Ack frame, or in the case of a fragment sequence, to the end of the Ack frame following the next fragment.

The defer logic circuitry may reside in one or more non-AP STAs and an AP STA and the defer logic circuitry of the one or more non-AP STAs and/or the AP STA may cause transmission of the defer signal concurrently or simultaneously. Note that, in some embodiments, the defer logic circuitry may cause transmission of the defer signal an interframe space (IFS) (such as a PIFS or a DIFS) after detection of a clear channel via, e.g., a CCA, at the start of the rTWT SP. In some embodiments, the defer logic circuitry may cause transmission of the defer signal an IFS after detection of a clear channel and within a certain time margin prior to the start of the rTWT SP.

Within a certain time margin prior to the start of the rTWT SP may mean 0.5 milliseconds (ms), 0.25 ms, 0.75 ms, or within a range of 0.0 ms to 1.5 ms prior to the start of the rTWT SP. In many embodiments, the definition of within a certain time margin prior to the start of the rTWT SP may be defined based on a duration of a defer signal such that the defer signal overlaps the rTWT SP sufficiently for STAs to detect the defer signal during the rTWT SP, causing the non-member STAs or the STAs that did not also transmit the defer signal to detect the defer signal via, e.g., a CCA. The non-member STAs or the STAs that did not also transmit the defer signal may, after detecting the defer signal, determine that the channel is busy, refrain from access to the channel, and begin a backoff procedure (time duration countdown) after determining that the channel is idle. The backoff procedure for each station may involve decrementing a backoff count. The backoff count is decremented based on clock cycles while the medium or channel remains idle. Otherwise, the backoff count may be reset and may begin again after the channel becomes idle.

After causing transmission of the defer signal, non-AP STAs that are members of the rTWT SP and/or the AP STA that signaled the rTWT SP in, e.g., a beacon frame, may contend for access to the rTWT SP.

In some embodiments, if defer logic circuitry of an AP STA advertises an rTWT SP schedule that is trigger-enabled in its beacon frames, then within the rTWT SP, the AP STA is allowed to use the prioritized channel access and send a defer signal, e.g., a PIFS or DIFS after the end of the previous TxOP. In some embodiments, the defer logic circuitry may define rules such that the AP is allowed to send the defer signal also in contention periods that are within a certain time margin (e.g., in a range of 0.0 ms to 1.5 ms) before the start of the rTWT SP, because there can be many cases where TxOP owners supporting rTWT SP will end their TxOP not exactly at the start of the rTWT SP, but a little bit before.

Following the transmission of the defer signal (which will delay other STAs and forbid the other STAs from contending until a defer time ends), the AP STA may be able to participate in a mini-contention (in a contention period) that may allow it to access the medium before the defer time ends. The defer time is the amount of time that the non-member non-AP STAs will remain off the medium after detection of the defer signal via, e.g., the CCA. With this rule, the AP STA may, advantageously have a much higher chance to access the medium.

In some embodiments, if the defer logic circuitry of an AP STA advertises an rTWT SP schedule that is trigger-enabled in its beacon frames. Within the rTWT SP, the defer logic circuitry may include a mode field in the TWT parameter information element of a TWT element in the beacon frame. The mode field may identify the rTWT SP as a mode 1 where member STAs may send a defer signal but may not contend during the mini-contention for access to the medium during the defer time. The may alternatively identify the rTWT as a mode 2 where member STAs may send a defer signal and may contend during the mini-contention for access to the medium during the defer time.

In many embodiments, the defer logic circuitry may also define a non-trigger-enabled rTWT schedule mechanism. In such a mode, the associated STAs that are members of the rTWT schedule are allowed to access the medium and are supposed to attain prioritized access to the medium. In such embodiments, the defer logic circuitry may use the defer signal prioritized access as the tool to get prioritized access for the STAs that are members of the non-trigger-enabled rTWT SP. The defer logic circuitry of these STAs may use the prioritized access and transmit a defer signal a PIFS or DIFS after the end of the previous TxOP within any rTWT SP. In some embodiments, the defer logic circuitry may define rules such that the STAs are allowed to send the defer signal a certain margin of time before the start of the rTWT SP. Following the transmission of the defer signal, the STAs that are members and that sent the defer signal will participate in the mini-contention for prioritized access and one of these STAs may gain channel access before the end of the defer time.

Embodiments may associate links of more than one stations (STAs) of multi-link devices (MLDs). Links may be established (or logical) communications channels or connections between MLDs. MLDs include more than one stations (STAs). For instance, an access point (AP) MLD and a non-AP MLD may both include STAs configured for multiple frequency bands such as a first STA configured for 2.4 gigahertz (GHz) communications, a second STA configured for 5 GHz communications, and a third STA configured for 6 GHz communications.

In many embodiments discussed herein, MLDs have STAs operating on the same set of carrier frequencies but MLDs are not limited to STAs with any particular set of carrier frequencies. For example, embodiments may comprise MLDs that have a set of STAs operating on one or more overlapping carrier frequencies such as STAs with carrier frequencies in a range of sub 1 GHz, 1 GHz to 7.25 GHz, 7.25 GHz to 45 GHz, above 45 GHz, around 60 GHz, and/or the like.

Note that STAs may be AP STAs or non-AP STAs and may each be associated with a specific link of an MLD. Note also that an MLD can include AP functionality in one or more STAs for one or more links and, if a STA of the MLD operates as an AP on a link, the STA is referred to as an AP STA. If the STA does not perform AP functionality, or does not operate as an AP, on a link, the STA is referred to as a non-AP STA. In many of the embodiments herein, the AP MLDs operate as AP STAs on active links, and the non-AP MLDs operate as non-AP STAs on active links. However, an AP MLD may also have STAs that operate as non-AP STAs on the same extended service set (ESS) or basic service set (BSS) or other ESS's or BSS's.

In an infrastructure BSS, the IEEE 802.1X Authenticator medium access control (MAC) address (AA) and the AP STA's MAC address are the same, and the Supplicant's MAC address (SPA) and the non-AP STA's MAC address are the same. Between an AP MLD and a non-AP MLD, in many embodiments, the IEEE 802.1X Authenticator MAC address (AA) may be set to the MLD MAC address of the AP MLD, and the Supplicant's MAC address (SPA) may be set to the MLD MAC address of the non-AP MLD, but embodiments are not limited to such MAC address assignments. Note that the MAC address for a MLD (AP or non-AP) may be the same as a MAC address of one of the STAs of the MLD or may be different from the MAC addresses of all the STAs of the MLD. For instance, if the MLD has three STAs, the MAC address of the MLD may be the same MAC address as, e.g., the first STA of the MLD in some embodiments. In other embodiments, the MAC address of the MLD may be different from all three of the MAC addresses of the STAs of the MLD.

In some embodiments, the MAC address is encoded as 6 octets, taken to represent an unsigned integer. The first octet of the MAC address may be used as the most significant octet. The bit numbering conventions may be used within each octet. In such embodiments, this results in a sequence of 48 bits represented such that bit 0 is the first transmitted bit (Individual/Group bit) and bit 47 is the last transmitted bit. Note that the value of the MAC address included in a field of a MAC frame may comprise the complete MAC address, a compressed or encoded MAC address, a truncated MAC address such as a set of the least significant bits of the MAC address or the last four bits of a MAC address, and/or the like.

Embodiments may perform wireless communications on channels or links such as a 2.4 GHz link, a 5 GHz link, or a 6 GHz link. Note that while many examples of embodiments discussed herein discuss 2.4 GHz link, a 5 GHz link, or a 6 GHz links, links with have any carrier frequency. Some embodiments may advantageously use of 2.4 GHz links, 5 GHz links, or 6 GHz links due to the proliferation of 2.4 GHz link and 5 GHz link devices as well as the current utility and efficiencies related to the implementation of 6 GHz links. Embodiments discussed herein will be advantageous from an operational and efficiency standpoint regardless of the carrier frequencies.

In some embodiments, the AP MLD may include a 6 GHz AP STA that is also a channel enabler for the 6 GHz channel. In such embodiments, the channel enabler may connect via, e.g., the Internet to an automated frequency coordination (AFC) system and operate under the control of the AFC system to prevent harmful interference to microwave links that operate in the band. The AFC system may determine on which frequencies and at what power levels standard-power devices may operate and may, in some embodiments, be aware of the location of the AP MLD. For instance, in some embodiments, standard power devices may be able to operate on 5.925-6.425 GHz and 6.525-6.875 GHz portions of the 6 GHz channel.

Note that a channel enabler may operate on other frequencies such as 2.4 GHz or 5 GHz to offer more control to a network operator even though such frequencies may not require connection to an AFC system or the like.

For maintaining a quality of service (QoS), many embodiments define two or more access categories. Access categories may be associated with traffic to define priorities (in the form of parameter sets) for access to a channel for transmissions (or communications traffic) such as managed link transmissions. Many embodiments implement an enhanced distributed channel access (EDCA) protocol to establish the priorities. In some embodiments, the EDCA protocol includes access categories such as best efforts (AC_BE), background (AC_BK), video (AC_VI), and voice (AC_VO) in addition to the AC_PL. Protocols for various standards provide default values for parameter sets for each of the access categories and the values may vary depending upon the type of a STA, the operational role of the STA, and/or the like.

Embodiments may also comprise defer logic circuitry to facilitate communications by stations (STAs) in accordance with different versions of Institute of Electrical and Electronics Engineers (IEEE) 802.11 standards for wireless communications (generally referred to as “Wi-Fi”) such as IEEE 802.11-2020, December 2020; IEEE P802.11be™/D2.2, October 2022; IEEE P802.11ax-2021™, IEEE P802.11ay-2021™, IEEE P802.11az™/D3.0, IEEE P802.11ba-2021™ IEEE P802.11bb™/D0.4, IEEE P802.11bc™/D1.02, and IEEE P802.11bd™/D1.1.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

Various embodiments may be designed to address different technical problems associated with prioritized access such as fixing a gap that might allow an AP or member STAs of a rTWT to fail to gain access during a contention period defined for prioritized access; determining when to start the contention period for prioritized access, rules for performance of prioritized access for trigger-enabled rTWT SPs, rules for performance of prioritized access for non-trigger enabled rTWT SPs, determining modes of operation for trigger-enabled rTWT SPs, how to signal modes of operation for trigger-enabled rTWTs, and/or the like.

Different technical problems such as those discussed above may be addressed by one or more different embodiments. Embodiments may address one or more of these problems associated with prioritized access. For instance, some embodiments that address problems associated with prioritized access may do so by one or more different technical means, such as, causing transmission of a defer signal in a contention period that is concurrent with a start of a restricted target wake time service period (rTWT SP), the apparatus comprising at least part of a first station (STA), wherein the first STA has an existing agreement with a second STA for the rTWT SP, at least one of the first STA and the second STA to comprise data associated with a predictable latency access category (AC_PL) of an enhanced distributed channel access (EDCA) mechanism; contending for access to a medium for transmission of the data during the contention window; and/or the like.

Several embodiments comprise central servers, access points (APs), and/or stations (STAs) such as modems, routers, switches, servers, workstations, netbooks, mobile devices (Laptop, Smart Phone, Tablet, and the like), sensors, meters, controls, instruments, monitors, home or office appliances, Internet of Things (IoT) gear (watches, glasses, headphones, and the like), and the like. Some embodiments may provide, e.g., indoor and/or outdoor “smart” grid and sensor services. In various embodiments, these devices relate to specific applications such as healthcare, home, commercial office and retail, security, and industrial automation and monitoring applications, as well as vehicle applications (automobiles, self-driving vehicles, airplanes, and the like), and the like.

Some embodiments may facilitate wireless communications in accordance with multiple standards. Some embodiments may comprise low power wireless communications like Bluetooth®, cellular communications, and messaging systems. Furthermore, some wireless embodiments may incorporate a single antenna while other embodiments may employ multiple antennas or antenna elements.

While some of the specific embodiments described below will reference the embodiments with specific configurations, those of skill in the art will realize that embodiments of the present disclosure may advantageously be implemented with other configurations with similar issues or problems.

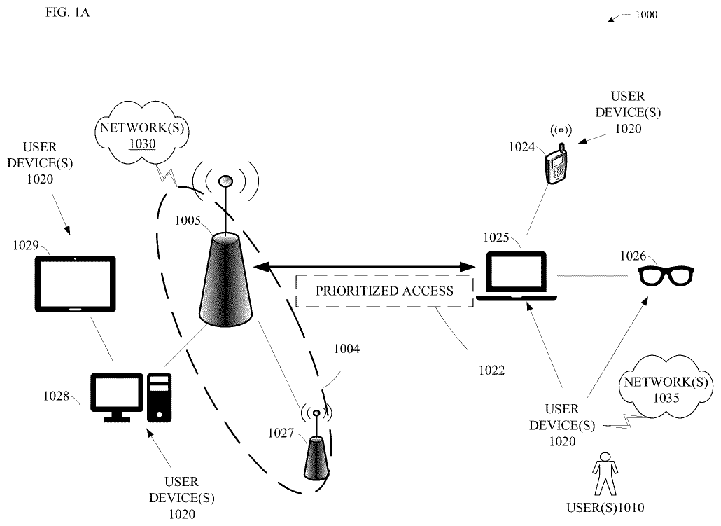

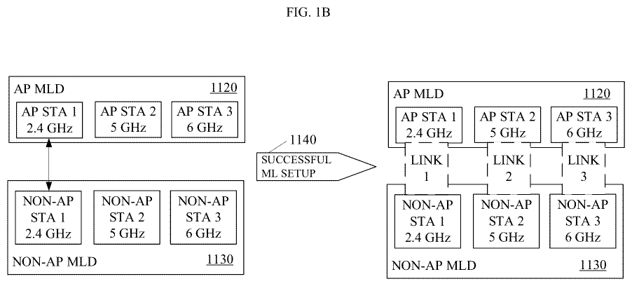

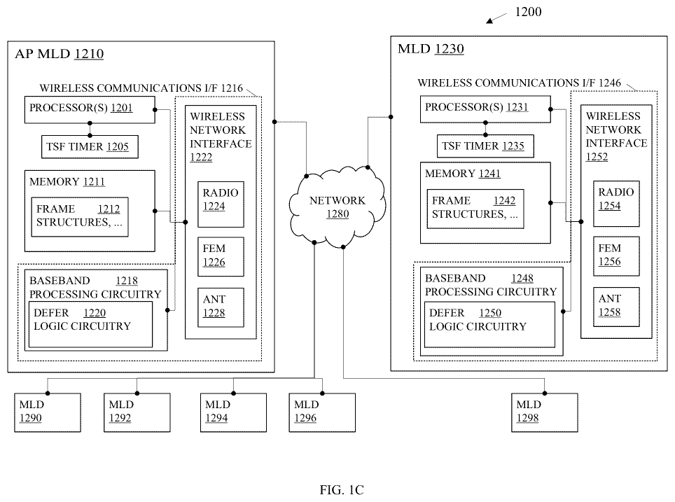

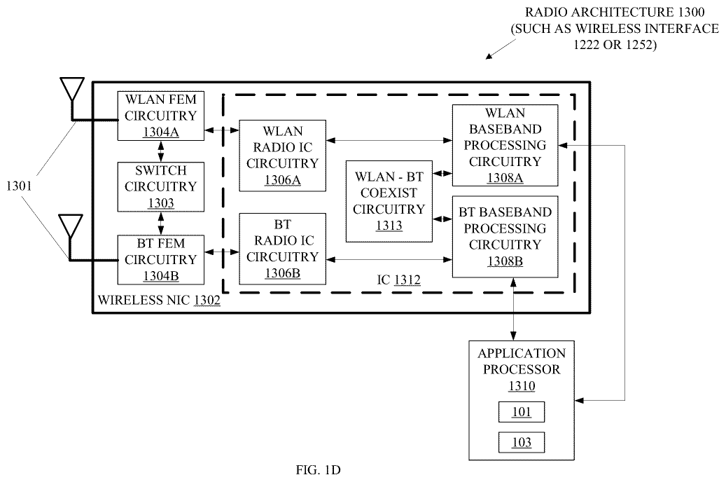

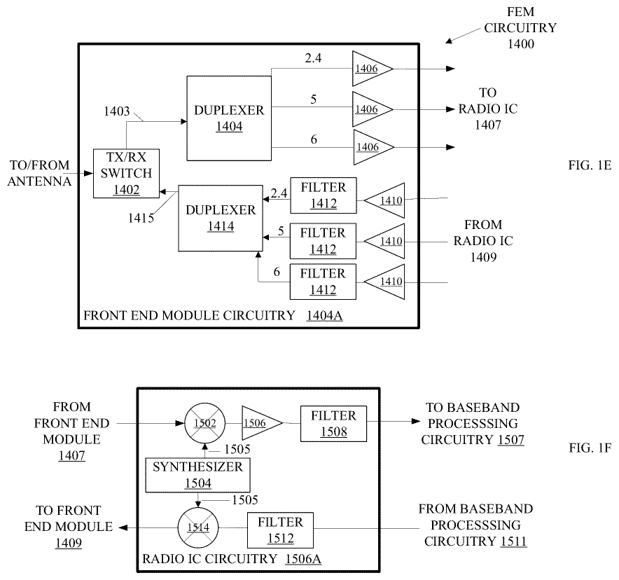

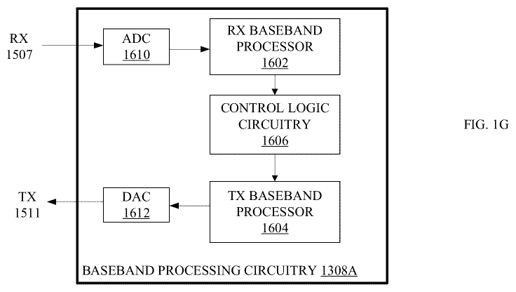

FIG. 1A depicts a system diagram illustrating an embodiment of a network environment for defer logic circuitry, in accordance with one or more example embodiments. Wireless network 1000 may include one or more access point (AP) multi-link devices (AP-MLDs) 1005 and 1027, and one or more user devices 1020 (non-AP MLDs), which may communicate in accordance with IEEE 802.11 communication standards.

In the present embodiment, the AP MLD 1005 may comprise a collocated set of AP stations (STAs) and the AP MLD 1027 may comprise a collocated set of AP STAs. The user device(s) 1020 may comprise mobile devices that are non-stationary (e.g., not having fixed locations) and/or stationary devices. In some embodiments, the user device(s) 1020 and the AP-MLDs 1005 and 1027 may include one or more computer systems similar to the MLDs shown in FIGS. 1B-1G and/or the example machine/system of FIGS. 5, 6, 7, and 8.

One or more illustrative user device(s) 1020 and/or AP-MLDs 1005 and 1027 may be operable by one or more user(s) 1010. It should be noted that any addressable unit may be a station (STA) and MLDs may comprise one or more collocated STAs contained in a single housing, individual housings, or a combination thereof. A STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 1020 and the AP-MLDs 1005 and 1027 may include STAs. The one or more illustrative user device(s) 1020 and/or AP-MLDs 1005 and 1027 may operate as an extended service set (ESS), a basic service set (BSS), a personal basic service set (PBSS), or a control point/access point (PCP/AP).

The user device(s) 1020 (e.g., 1024, 1025, 1026, 1028, or 1029) and/or AP-MLDs 1005 and 1027 may include any suitable processor-driven device including, but not limited to, a mobile device or a non-mobile, e.g., a static device. For example, user device(s) 1020 and/or AP-MLDs 1005 and 1027 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless network interface, a mobile or portable GPS device, a DVB device, a relatively small computing device, a non-desktop computer, a “carry small live large” (CSLL) device, an ultra-mobile device (UMD), an ultra-mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

In some embodiments, the user device(s) 1020 and/or AP-MLDs 1005 and 1027 may also include mesh stations in, for example, a mesh network, in accordance with one or more IEEE 802.11 standards and/or 3GPP standards.

Any of the user device(s) 1020 (e.g., user devices 1024, 1025, 1026, 1028, and 1029) and AP-MLDs 1005 and 1027 may be configured to communicate with each other via one or more communications networks 1030 and/or 1035 wirelessly or wired. In some embodiments, the user device(s) 1020 may also communicate peer-to-peer or directly with each other with or without the AP-MLDs 1005 and 1027 and, in some embodiments, the user device(s) 1020 may also communicate peer-to-peer if enabled by the AP-MLDs 1005 and 1027.

Furthermore, the AP-MLDs 1005 and 1027 and one or more of the user devices may each comprise defer logic circuitry to implement prioritized access 1022 protocols, procedures, frames, and/or the like as discussed herein to improve the chances for predicted latency for devices such as augmented reality/virtual reality devices that may require periodic, low latency communications. In the present embodiment, the AP-MLDs 1005 and 1027 may comprise 2.4 GHz, 5 GHz, and 6 GHz STAs. Note that embodiments are not limited to STAs capable of any particular set of carrier frequencies.

The defer logic circuitry of the non-AP MLDs such as the user devices 1020 and the AP-MLDs 1005 and 1027 may negotiate rTWT SPs to perform prioritized access 1022. For instance, the defer logic circuitry of the laptop 1025 may generate and cause transmission of a TWT request frame such as an association request frame, a reassociation request frame, a TWT setup frame, and/or another MAC frame that includes one or more TWT elements to the AP MLD 1005.

The AP MLD 1005 may respond with a TWT response frame to accept, accept with modification, or reject the request to establish an agreement for an rTWT SP. Note that the negotiation may involve establishing one-time or periodic rTWT SPs. Note also that the rules related to the establishment of the rTWT SP, which may be enforceable by the defer logic circuitry of the AP MLD 1005 and/or STAs that are members of the rTWT SP, may indicate that a TxOP prior to the rTWT SP must terminate prior to the start of the rTWT SP.

After negotiating the rTWT SP, a TxOP may end prior to the start of the rTWT SP. In some embodiments, if the TxOP ends with time remaining before the rTWT SP, a contention period for the rTWT SP may start prior to the start of the rTWT SP such as at a margin time prior to the start of the rTWT SP. In either case, the AP MLD 1005 and/or the laptop 1025 may determine that the medium is idle and wait a PIFS or DIFS prior to causing transmission of a defer signal. In some embodiments, both the AP MLD 1005 and the laptop may transmit the defer signal concurrently or simultaneously. The defer signal may be configured to cause non-member STAs of the rTWT SP and other STAs such as legacy STAs to determine, via CCA, that the medium is busy so that these STAs remain off the medium and do not contend for the medium during the contention period of the rTWT SP.

After causing transmission of the defer signal, the AP MLD 1005 and/or the laptop 1025 may contend for access to the medium. In many embodiments, the AP MLD 1005 and/or the laptop 1025 may only cause transmission of the defer signal if the AP MLD 1005 or the laptop has data queued having defined access categories such as an access category of AC_PL.

Thereafter, the STA with the smallest backoff count may gain access to the medium and perform communications during the rTWT SP. In some embodiments, if time remains during the rTWT SP, another member of the rTWT SP that caused transmission of the defer signal may gain access to the medium during the rTWT SP to perform communications.

Any of the communications networks 1030 and/or 1035 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 1030 and/or 1035 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 1030 and/or 1035 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 1020 (e.g., user devices 1024, 1025, 1026, 1028, and 1029), the AP MLD 1005, and the AP-MLD 1027 may include one or more communications antennas. The one or more communications antennas may be any suitable type of antennas corresponding to the communications protocols used by the user device(s) 1020 (e.g., user devices 1024, 1025, 1026, 1028, and 1029) and AP-MLD 1005. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 1020, AP MLD 1005, and/or AP-MLD 1027.

Any of the user device(s) 1020 (e.g., user devices 1024, 1025, 1026, 1028, and 1029), the AP MLD 1005, and AP-MLD 1027 may be configured to wirelessly communicate in a wireless network. Any of the user device(s) 1020 (e.g., user devices 1024, 1025, 1026, 1028, and 1029), the AP MLD 1005, and AP-MLD 1027 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 1020 (e.g., user devices 1024, 1025, 1026, 1028, and 1029), the AP MLD 1005, and AP-MLD 1027 may be configured to perform any given directional transmission towards one or more defined transmit sectors. Any of the user device(s) 1020 (e.g., user devices 1024, 1025, 1026, 1028, and 1029), the AP MLD 1005, and AP-MLD 1027 may be configured to perform any given directional reception from one or more defined receive sectors.

MIMO beamforming in a wireless network may be accomplished using RF beamforming and/or digital beamforming. In some embodiments, in performing a given MIMO transmission, user devices 1020, AP MLD 1005, and/or AP-MLD 1027 may be configured to use all or a subset of its one or more communications antennas to perform MIMO beamforming.

Any of the user devices 1020 (e.g., user devices 1024, 1025, 1026, 1028, and 1029), the AP MLD 1005, and AP-MLD 1027 may include any suitable radio and/or transceiver for transmitting and/or receiving radio frequency (RF) signals in the bandwidth and/or channels corresponding to the communications protocols utilized by any of the user device(s) 1020 and AP-MLD 1005 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g., 802.11b, 802.11g, 802.11n, 802.11ax, 802.11be), 5 GHz channels (e.g., 802.11n, 802.11ac, 802.11ax, 802.11be), 6 GHz (e.g., 802.11be), or 60 GHz channels (e.g., 802.11ad, 802.11ay, Next Generation Wi-Fi) or 800 MHz channels (e.g., 802.11ah). The communications antennas may operate at 28 GHz, 40 GHz, or any carrier frequency between 45 GHz and 75 GHz. It should be understood that this list of communication channels in accordance with certain 802.11 standards is only a partial list, and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g., IEEE 802.11af, IEEE 802.22), white band frequency (e.g., white spaces), or other packetized radio communications. The radio component may include any known receiver and baseband suitable for communicating via the communications protocols. The radio component may further include a power amplifier (PA), a low noise amplifier (LNA), additional signal amplifiers, an analog-to-digital (A/D) converter, one or more buffers, and a digital baseband.

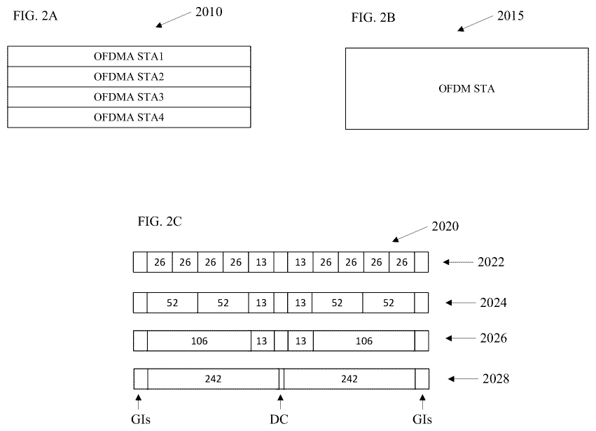

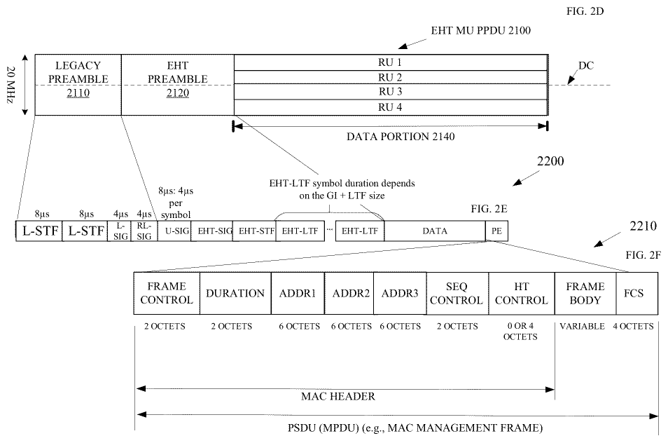

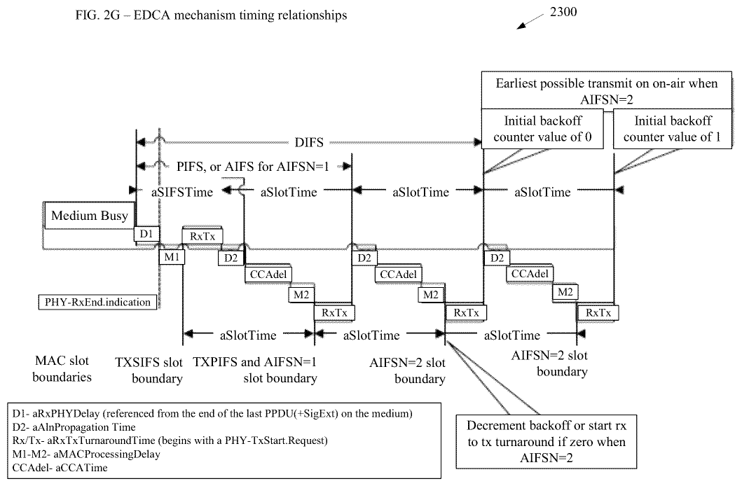

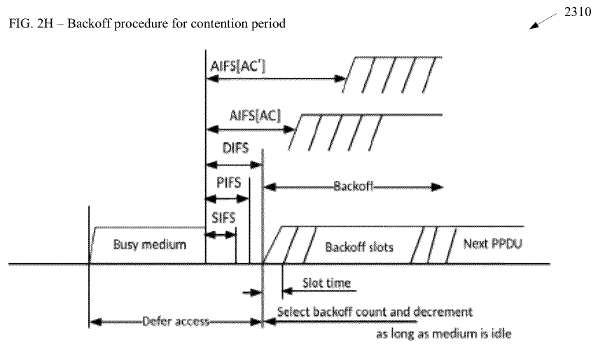

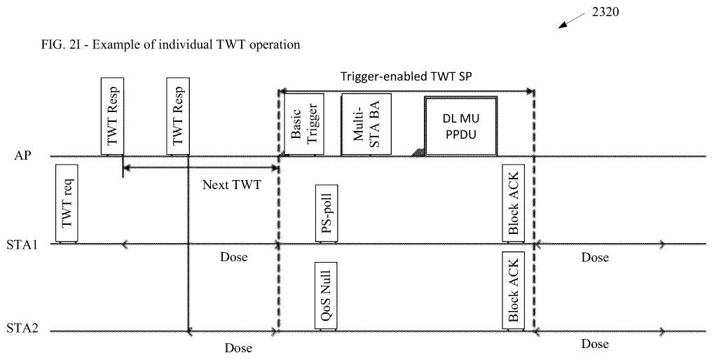

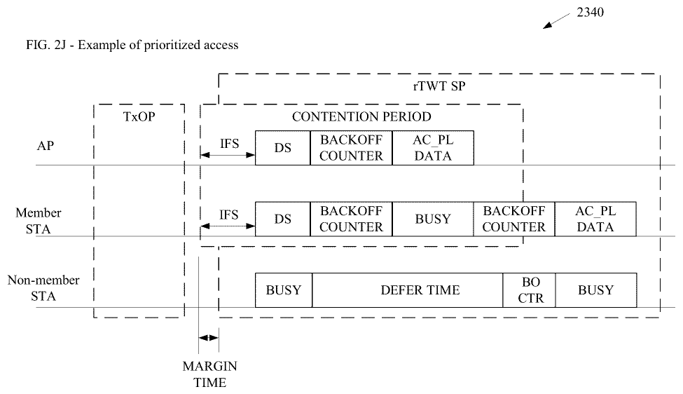

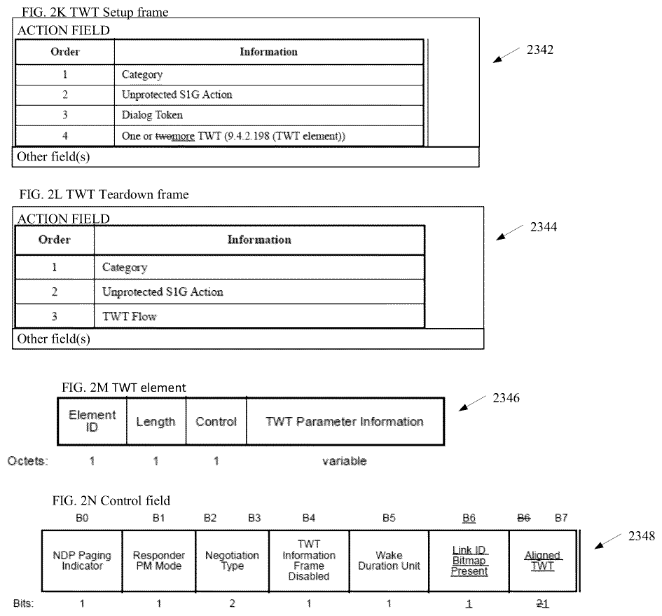

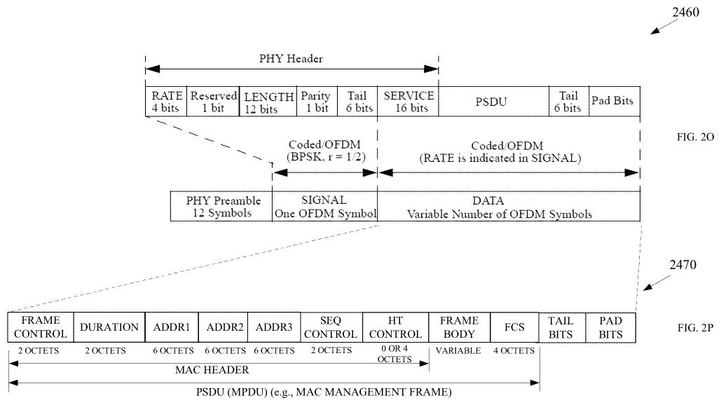

FIG. 1B depicts an embodiment 1100 illustrating interactions between stations (STAs) to establish multiple links between an access point (AP) multi-link device (MLD) 1120 and a non-AP MLD 1130. During the establishment of the links, defer logic circuitry of the AP MLD 1120 and the non-AP MLD 1130 may negotiate the establishment of one or more rTWT SPs to perform prioritized access by including one or more TWT elements in (re)association request and response frames, as discussed herein. The AP MLD 1120 has three affiliated AP STAs: AP STA 1 operates on 2.4 GHz band, AP STA 2 operates on 5 GHz band, and AP STA 3 operates on 6 GHz band. The non-AP STA 1 affiliated with the non-AP MLD 1130 sends an association request frame (or a reassociation request frame) to AP STA 1 affiliated with the AP MLD 1120. The association request frame may have a TA field set to the MAC address of the non-AP STA 1 and an RA field set to the MAC address of the AP STA 1. The association request frame may include complete information of non-AP STA 1, non-AP STA 2, and non-AP STA 3 to request up to four links to be setup (one link between AP STA 1 and non-AP STA 1, one link between AP STA 2 and non-AP STA 2, and one link between AP STA 3 and non-AP STA 3) and a multi-link (ML) element that indicates the MLD MAC address of the non-AP MLD 1130. In some embodiments, the association request frame may include a sensing capabilities element such as the sensing capabilities element 2302 shown in FIG. H, and may comprise a secure sensing subfield in the sensing field of the sensing capabilities element such as the sensing field 2304 as shown in FIG. 2I.

AP STA 1, affiliated with the AP MLD 1120, may send an association response frame to non-AP STA 1 affiliated with the non-AP MLD 1130 with a TA field of the association response frame is set to the MAC address of the AP STA 1 and an RA field of the association response frame set to the MAC address of the non-AP STA 1, to indicate successful multi-link setup 1140. The association response frame may include complete information of AP STA 1, AP STA 2, and AP STA 3 and an ML element that indicates the MLD MAC address of the AP MLD 1120. After successful ML setup between the non-AP MLD 1130 and the AP MLD 1120, three links are setup (LINK 1 between AP 1 and non-AP STA 1, LINK 2 between AP 2 and non-AP STA 2, and LINK 3 between AP STA 3 and non-AP STA 3).

In some embodiments, the non-AP MLD 1130 may associate with less than all the links available from the AP MLD 1120 for various reasons. For instance, in some embodiments, the non-AP MLD 1130 may only be capable of establishing two of the links. In some embodiments, the non-AP MLD 1130 may establish a link with a second AP MLD because the second AP MLD may have a better signal-to-noise ratio associated with one or more links and be associated with the same ESS. In some embodiments, the non-AP MLD 1130 may establish a link with a second AP MLD because the second AP MLD may be associated with a different ESS or a BSS that is not associated with the BSS of the AP MLD 1120.

During the association process, the AP MLD 1120 may establish communications protocols including identification of any parameters that differ from default parameters, preferential communications protocols, and/or negotiate communications protocols for the links.

FIG. 1C depicts an embodiment of a system 1200 including multiple MLDs to implement transition logic circuitry, in accordance with one or more example embodiments. System 1200 may transmit or receive as well as generate, decode, and interpret transmissions between an AP MLD 1210 and multiple MLDs 1230, 1290, 1292, 1294, 1296, and 1298, associated with the AP MLD 1210. The AP MLD 1210 may be wired and wirelessly connected to each of the MLDs 1230, 1290, 1292, 1294, 1296, and 1298.

In some embodiments, the AP MLD 1210 may one of multiple AP MLDs affiliated with a collocated AP MLD (not shown) and MLD 1230 may include one or more computer systems similar to that of the example machines/systems of FIGS. 5, 6, 7, and 8.

Each MLD 1230, 1290, 1292, 1294, 1296, and 1298 may include defer logic circuitry, such as the defer logic circuitry 1250 of MLD 1230, for prioritized access policies, rules, and procedures as discussed herein.

To negotiate an agreement for one or more rTWT SPs with the AP MLD 1210, each of the MLDs 1230, 1290, 1292, 1294, 1296, and 1298 may transmit an association request frame or reassociation request frame to the AP MLD 1210 and include one or more TWT elements. Note that for MLDs, the TWT elements may specify a link identifier (ID) associated with the rTWT SP. The defer logic circuitry such as the defer logic circuitry 1250 of MLD 1230, for instance, may transmit one or more TWT elements in the association request or response frame, a reassociation request or response frame, a probe request or response frame, and/or in another MAC frame. The one or more TWT elements may comprise TWT parameters in a TWT parameter information field including a field for restricted parameters. In some embodiments, the field for restricted parameters may comprise a mode subfield to indicate a mode for trigger-enabled rTWT SPs.

After sending one or more the TWT elements in a TWT request frame, the AP MLD 1210 may negotiate the parameters in one or more of the one or more TWT elements with the non-AP MLD 1230 by including different rTWT SP parameters in one or more of the one or more TWT elements. In some embodiments, the AP MLD 1210 may negotiate the parameters of the one or more rTWT SPs by accepting the one or more rTWT SPs defined in the parameters of the one or more TWT elements.

After negotiating the rTWT SPs, the AP MLD 1210 and/or one or more of the non-AP MLDs may transmit a defer signal after a PIFS or DIFS during a contention period that starts at or a margin time before an rTWT SP. The defer signal may cause non-AP MLDs or other non-AP STAs that did not cause transmission of a defer signal to determine via CCA that the medium is busy and to defer another attempt for a time period based on the definition of the defer signal.

After causing transmission of the defer signal, the AP MLD 1210 and/or one or more of the non-AP MLDs that are members of the rTWT SP and that transmitted the defer signal, may contend for access to the medium by decrementing a backoff count. The MLD that reaches zero first (assuming the medium does not become busy in the interim) may access the medium to perform, communications of, e.g., AC_PL data. In some embodiments, for instance, the AP MLD 1210 may win the contention and transmit trigger frames to one or more non-AP MLDs or non-AP STAs to trigger uplink communications. In other embodiments, the AP MLD 1210 may cause transmission of downlink communications such as data buffered at the AP MLD 1210 for the non-AP MLD 1230 and/or other non-AP MLDs.

The AP MLD 1210 and MLD 1230 may comprise processor(s) 1201 and memory 1231, respectively. The processor(s) 1201 may comprise any data processing device such as a microprocessor, a microcontroller, a state machine, and/or the like, and may execute instructions or code in the memory 1211. The memory 1211 may comprise a storage medium such as Dynamic Random Access Memory (DRAM), read only memory (ROM), buffers, registers, cache, flash memory, hard disk drives, solid-state drives, or the like. The memory 1211 may store the frames, frame structures, frame headers, etc., 1212 and may also comprise code to generate, scramble, encode, decode, parse, and interpret MAC frames and/or PHY frames and physical layer protocol data units (PPDUs).

The baseband processing circuitry 1218 may comprise a baseband processor and/or one or more circuits to implement an MLD station management entity (MM-SME) and a station management entity (SME) per link. The MM-SME may coordinate management of, communications between, and interactions between SMEs for the links.

In some embodiments, the SME may interact with a MAC layer management entity to perform MAC layer functionality and a PHY management entity to perform PHY functionality. In such embodiments, the baseband processing circuitry 1218 may interact with processor(s) 1201 to coordinate higher layer functionality with MAC layer and PHY functionality.

In some embodiments, the baseband processing circuitry 1218 may interact with one or more analog devices to perform PHY functionality such as scrambling, encoding, modulating, and the like. In other embodiments, the baseband processing circuitry 1218 may execute code to perform one or more of the PHY functionality such as scrambling, encoding, modulating, and the like.

The MAC layer functionality may execute MAC layer code stored in the memory 1211. In further embodiments, the MAC layer functionality may interface the processor(s) 1201.

The MAC layer functionality may communicate with the PHY via the SME to transmit a MAC frame such as a multiple-user (MU) ready to send (RTS), referred to as a MU-RTS, in a PHY frame such as an extremely high throughput (EHT) MU PPDU to the MLD 1230. The MAC layer functionality may generate frames such as management, data, and control frames.

The PHY may prepare the MAC frame for transmission by, e.g., determining a preamble to prepend to a MAC frame to create a PHY frame. The preamble may include one or more short training field (STF) values, long training field (LTF) values, and signal (SIG) field values. A wireless network interface 1222 or the baseband processing circuitry 1218 may prepare the PHY frame as a scrambled, encoded, modulated PPDU in the time domain signals for the radio 1224. Furthermore, the TSF timer 1205 may provide a timestamp value to indicate the time at which the PPDU is transmitted.

After processing the PHY frame, a radio 1225 may impress digital data onto subcarriers of RF frequencies for transmission by electromagnetic radiation via elements of an antenna array or antennas 1224 and via the network 1280 to a receiving MLD STA of a MLD such as the MLD 1230.

The wireless network I/F 1222 also comprises a receiver. The receiver receives electromagnetic energy, extracts the digital data, and the analog PHY and/or the baseband processor 1218 decodes a PHY frame and a MAC frame from a PPDU.

The MLD 1230 may receive a PPDU of the EHT MU PPDU from the AP MLD 1210 via the network 1280. The MLD 1230 may comprise processor(s) 1231 and memory 1241. The processor(s) 1231 may comprise any data processing device such as a microprocessor, a microcontroller, a state machine, and/or the like, and may execute instructions or code in the memory 1241. The memory 1241 may comprise a storage medium such as Dynamic Random Access Memory (DRAM), read only memory (ROM), buffers, registers, cache, flash memory, hard disk drives, solid-state drives, or the like. The memory 1241 may store 1242 the frames, frame structures, frame headers, etc., and may also comprise code to generate, scramble, encode, decode, parse, and interpret MAC frames and/or PHY frames (PPDUs).

The baseband processing circuitry 1248 may comprise a baseband processor and/or one or more circuits to implement a SME and the SME may interact with a MAC layer management entity to perform MAC layer functionality and a PHY management entity to perform PHY functionality. In such embodiments, the baseband processing circuitry 1248 may interact with processor(s) 1231 to coordinate higher layer functionality with MAC layer and PHY functionality.

In some embodiments, the baseband processing circuitry 1218 may interact with one or more analog devices to perform PHY functionality such as descrambling, decoding, demodulating, and the like. In other embodiments, the baseband processing circuitry 1218 may execute code to perform one or more of the PHY functionalities such as descrambling, decoding, demodulating, and the like.

The MLD 1230 may receive the PPDU of the EHT MU PPDU at the antennas 1258, which pass the signals along to the FEM 1256. The FEM 1256 may amplify and filter the signals and pass the signals to the radio 1254. The radio 1254 may filter the carrier signals from the signals and determine if the signals represent a PPDU. If so, analog circuitry of the wireless network I/F 1252 or physical layer functionality implemented in the baseband processing circuitry 1248 may demodulate, decode, descramble, etc. the PPDU. The baseband processing circuitry 1248 may identify, parse, and interpret a MAC service data unit (MSDU) from the physical layer service data unit (PSDU) of the EHT MU PPDU.

FIG. 1D is an embodiment of a block diagram of a radio architecture 1300 such as the wireless communications I/F 1222 and 1252 in accordance with some embodiments that may be implemented in, e.g., the AP MLD 1210 and/or the MLD 1230 of FIG. 1C. The radio architecture 1300 may include radio front-end module (FEM) circuitry 1304a-b, radio IC circuitry 1306a-b and baseband processing circuitry 1308a-b. The radio architecture 1300 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1304a-b may include a WLAN or Wi-Fi FEM circuitry 1304a and a Bluetooth (BT) FEM circuitry 1304b. The WLAN FEM circuitry 1304a may include a receive signal path comprising circuitry configured to operate on WLAN RF signals received from one or more antennas 1301, to amplify the received signals and to provide the amplified versions of the received signals to the WLAN radio IC circuitry 1306a for further processing. The BT FEM circuitry 1304b may include a receive signal path which may include circuitry configured to operate on BT RF signals received from one or more antennas 1301, to amplify the received signals and to provide the amplified versions of the received signals to the BT radio IC circuitry 1306b for further processing. FEM circuitry 1304a may also include a transmit signal path which may include circuitry configured to amplify WLAN signals provided by the radio IC circuitry 1306a for wireless transmission by one or more of the antennas 1301. In addition, FEM circuitry 1304b may also include a transmit signal path which may include circuitry configured to amplify BT signals provided by the radio IC circuitry 1306b for wireless transmission by the one or more antennas. In the embodiment of FIG. 1D, although FEM 1304a and FEM 1304b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1306a-b as shown may include WLAN radio IC circuitry 1306a and BT radio IC circuitry 1306b. The WLAN radio IC circuitry 1306a may include a receive signal path which may include circuitry to down-convert WLAN RF signals received from the FEM circuitry 1304a and provide baseband signals to WLAN baseband processing circuitry 1308a. BT radio IC circuitry 1306b may in turn include a receive signal path which may include circuitry to down-convert BT RF signals received from the FEM circuitry 1304b and provide baseband signals to BT baseband processing circuitry 1308b. WLAN radio IC circuitry 1306a may also include a transmit signal path which may include circuitry to up-convert WLAN baseband signals provided by the WLAN baseband processing circuitry 1308a and provide WLAN RF output signals to the FEM circuitry 1304a for subsequent wireless transmission by the one or more antennas 1301. BT radio IC circuitry 1306b may also include a transmit signal path which may include circuitry to up-convert BT baseband signals provided by the BT baseband processing circuitry 1308b and provide BT RF output signals to the FEM circuitry 1304b for subsequent wireless transmission by the one or more antennas 1301. In the embodiment of FIG. 1D, although radio IC circuitries 1306a and 1306b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 1308a-b may include a WLAN baseband processing circuitry 1308a and a BT baseband processing circuitry 1308b. The WLAN baseband processing circuitry 1308a may include a memory, such as, for example, a set of RAM arrays in a Fast Fourier Transform or Inverse Fast Fourier Transform block (not shown) of the WLAN baseband processing circuitry 1308a. Each of the WLAN baseband circuitry 1308a and the BT baseband circuitry 1308b may further include one or more processors and control logic to process the signals received from the corresponding WLAN or BT receive signal path of the radio IC circuitry 1306a-b, and to also generate corresponding WLAN or BT baseband signals for the transmit signal path of the radio IC circuitry 1306a-b. Each of the baseband processing circuitries 1308a and 1308b may further include physical layer (PHY) and medium access control layer (MAC) circuitry, and may further interface with a device for generation and processing of the baseband signals and for controlling operations of the radio IC circuitry 1306a-b.

Referring still to FIG. 1D, according to the shown embodiment, WLAN-BT coexistence circuitry 1313 may include logic providing an interface between the WLAN baseband circuitry 1308a and the BT baseband circuitry 1308b to enable use cases requiring WLAN and BT coexistence. In addition, a switch circuitry 1303 may be provided between the WLAN FEM circuitry 1304a and the BT FEM circuitry 1304b to allow switching between the WLAN and BT radios according to application needs. In addition, although the antennas 1301 are depicted as being respectively connected to the WLAN FEM circuitry 1304a and the BT FEM circuitry 1304b, embodiments include within their scope the sharing of one or more antennas as between the WLAN and BT FEMs, or the provision of more than one antenna connected to each of FEM 1304a or 1304b.

In some embodiments, the front-end module circuitry 1304a-b, the radio IC circuitry 1306a-b, and baseband processing circuitry 1308a-b may be provided on a single radio card, such as wireless network interface card (NIC) 1302. In some other embodiments, the one or more antennas 1301, the FEM circuitry 1304a-b and the radio IC circuitry 1306a-b may be provided on a single radio card. In some other embodiments, the radio IC circuitry 1306a-b and the baseband processing circuitry 1308a-b may be provided on a single chip or integrated circuit (IC), such as IC 1312.

In some embodiments, the wireless NIC 1302 may include a WLAN radio card and may be configured for Wi-Fi communications, although the scope of the embodiments is not limited in this respect. In some of these embodiments, the radio architecture 1300 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 1300 may be part of a Wi-Fi communication station (STA) such as a wireless access point (AP), a base station or a mobile device including a Wi-Fi device. In some of these embodiments, radio architecture 1300 may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2020, IEEE 802.11ay-2021, IEE 802.11ba-2021, IEEE 802.11ax-2021, and/or IEEE 802.11be standards and/or proposed specifications for WLANs, although the scope of embodiments is not limited in this respect. The radio architecture 1300 may also be suitable to transmit and/or receive communications in accordance with other techniques and standards.

In some embodiments, the radio architecture 1300 may be configured for high-efficiency Wi-Fi (HEW) communications in accordance with the IEEE 802.11ax-2021 standard. In these embodiments, the radio architecture 1300 may be configured to communicate in accordance with an OFDMA technique, although the scope of the embodiments is not limited in this respect.

In some other embodiments, the radio architecture 1300 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1D, the BT baseband circuitry 1308b may be compliant with a Bluetooth (BT) connectivity specification such as Bluetooth 5.0, or any other iteration of the Bluetooth specification.

In some embodiments, the radio architecture 1300 may include other radio cards, such as a cellular radio card configured for cellular (e.g., 5GPP such as LTE, LTE-Advanced or 7G communications).

In some IEEE 802.11 embodiments, the radio architecture 1300 may be configured for communication over various channel bandwidths including bandwidths having center frequencies of about 2.4 GHz, 5 GHz, and 6 GHz. The various bandwidths may include bandwidths of about 20 MHz, 40 MHz, 80 MHz, 160 MHz, 240 MHz, and 320 MHz with contiguous or non-contiguous bandwidths having increments of 20 MHz, 40 MHz, 80 MHz, 160 MHz, 240 MHz, and 320 MHz. The scope of the embodiments is not limited with respect to the above center frequencies, however.

FIG. 1E illustrates FEM circuitry 1400 such as WLAN FEM circuitry 1304a shown in FIG. 1 D in accordance with some embodiments. Although the example of FIG. 1E is described in conjunction with the WLAN FEM circuitry 1304a, the example of FIG. 1E may be described in conjunction with other configurations such as the BT FEM circuitry 1304b.

In some embodiments, the FEM circuitry 1400 may include a TX/RX switch 1402 to switch between transmit mode and receive mode operation. The FEM circuitry 1400 may include a receive signal path and a transmit signal path. The receive signal path of the FEM circuitry 1400 may include a low-noise amplifier (LNA) 1406 to amplify received RF signals 1403 and provide the amplified received RF signals 1407 as an output (e.g., to the radio IC circuitry 1306a-b (FIG. 1D)). The transmit signal path of the circuitry 1304a may include a power amplifier (PA) to amplify input RF signals 1409 (e.g., provided by the radio IC circuitry 1306a-b), and one or more filters 1412, such as band-pass filters (BPFs), low-pass filters (LPFs) or other types of filters, to generate RF signals 1415 for subsequent transmission (e.g., by one or more of the antennas 1301 (FIG. 1D)) via an example duplexer 1414.

In some dual-mode embodiments for Wi-Fi communication, the FEM circuitry 1400 may be configured to operate in the 2.4 GHz frequency spectrum, the 5 GHz frequency spectrum, or the 6 GHz frequency spectrum. In these embodiments, the receive signal path of the FEM circuitry 1400 may include a receive signal path duplexer 1404 to separate the signals from each spectrum as well as provide a separate LNA 1406 for each spectrum as shown. In these embodiments, the transmit signal path of the FEM circuitry 1400 may also include a power amplifier 1410 and a filter 1412, such as a BPF, an LPF or another type of filter for each frequency spectrum and a transmit signal path duplexer 1404 to provide the signals of one of the different spectrums onto a single transmit path for subsequent transmission by the one or more of the antennas 1301 (FIG. 1D). In some embodiments, BT communications may utilize the 2.4 GHz signal paths and may utilize the same FEM circuitry 1400 as the one used for WLAN communications.

FIG. 1F illustrates radio IC circuitry 1506a in accordance with some embodiments. The radio IC circuitry 1306a is one example of circuitry that may be suitable for use as the WLAN or BT radio IC circuitry 1306a/1306b (FIG. 1D), although other circuitry configurations may also be suitable. Alternatively, the example of FIG. 1F may be described in conjunction with the example BT radio IC circuitry 1306b.

In some embodiments, the radio IC circuitry 1306a may include a receive signal path and a transmit signal path. The receive signal path of the radio IC circuitry 1306a may include at least mixer circuitry 1502, such as, for example, down-conversion mixer circuitry, amplifier circuitry 1506 and filter circuitry 1508. The transmit signal path of the radio IC circuitry 1306a may include at least filter circuitry 1512 and mixer circuitry 1514, such as, for example, upconversion mixer circuitry. Radio IC circuitry 1306a may also include synthesizer circuitry 1504 for synthesizing a frequency 1505 for use by the mixer circuitry 1502 and the mixer circuitry 1514. The mixer circuitry 1502 and/or 1514 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 1F illustrates only a simplified version of a radio IC circuitry, and may include, although not shown, embodiments where each of the depicted circuitries may include more than one component. For instance, mixer circuitry 1514 may each include one or more mixers, and filter circuitries 1508 and/or 1512 may each include one or more filters, such as one or more BPFs and/or LPFs according to application needs. For example, when mixer circuitries are of the direct-conversion type, they may each include two or more mixers.

In some embodiments, mixer circuitry 1502 may be configured to down-convert RF signals 1407 received from the FEM circuitry 1304a-b (FIG. 1D) based on the synthesized frequency 1505 provided by synthesizer circuitry 1504. The amplifier circuitry 1506 may be configured to amplify the down-converted signals and the filter circuitry 1508 may include an LPF configured to remove unwanted signals from the down-converted signals to generate output baseband signals 1507. Output baseband signals 1507 may be provided to the baseband processing circuitry 1308a-b (FIG. 1D) for further processing. In some embodiments, the output baseband signals 1507 may be zero-frequency baseband signals, although this is not a requirement. In some embodiments, mixer circuitry 1502 may comprise passive mixers, although the scope of the embodiments is not limited in this respect.

In some embodiments, the mixer circuitry 1514 may be configured to up-convert input baseband signals 1511 based on the synthesized frequency 1505 provided by the synthesizer circuitry 1504 to generate RF output signals 1409 for the FEM circuitry 1304a-b. The baseband signals 1511 may be provided by the baseband processing circuitry 1308a-b and may be filtered by filter circuitry 1512. The filter circuitry 1512 may include an LPF or a BPF, although the scope of the embodiments is not limited in this respect.

In some embodiments, the mixer circuitry 1502 and the mixer circuitry 1514 may each include two or more mixers and may be arranged for quadrature down-conversion and/or upconversion respectively with the help of synthesizer 1504. In some embodiments, the mixer circuitry 1502 and the mixer circuitry 1514 may each include two or more mixers each configured for image rejection (e.g., Hartley image rejection). In some embodiments, the mixer circuitry 1502 and the mixer circuitry 1514 may be arranged for direct down-conversion and/or direct upconversion, respectively. In some embodiments, the mixer circuitry 1502 and the mixer circuitry 1514 may be configured for super-heterodyne operation, although this is not a requirement.

Mixer circuitry 1502 may comprise, according to one embodiment: quadrature passive mixers (e.g., for the in-phase (I) and quadrature phase (Q) paths). In such an embodiment, RF input signal 1407 from FIG. 1F may be downconverted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1505 of synthesizer 1504 (FIG. 1F). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1407 (FIG. 1E) may comprise a balanced signal, although the scope of the embodiments is not limited in this respect. The I and Q baseband output signals may be provided to low-noise amplifier, such as amplifier circuitry 1506 (FIG. 1F) or to filter circuitry 1508 (FIG. 1F).

In some embodiments, the output baseband signals 1507 and the input baseband signals 1511 may be analog baseband signals, although the scope of the embodiments is not limited in this respect. In some alternate embodiments, the output baseband signals 1507 and the input baseband signals 1511 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1504 may be a fractional-N synthesizer or a fractional N/N+1 synthesizer, although the scope of the embodiments is not limited in this respect as other types of frequency synthesizers may be suitable. For example, synthesizer circuitry 1504 may be a delta-sigma synthesizer, a frequency multiplier, or a synthesizer comprising a phase-locked loop with a frequency divider. According to some embodiments, the synthesizer circuitry 1504 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1504 may be provided by a voltage-controlled oscillator (VCO), although that is not a requirement. A divider control input may further be provided by either of the baseband processing circuitry 1308a-b (FIG. 1D) depending on the desired output frequency 1505. In some embodiments, a divider control input (e.g., N) may be determined from a look-up table (e.g., within a Wi-Fi card) based on a channel number and a channel center frequency as determined or indicated by the example application processor 1310. The application processor 1310 may include, or otherwise be connected to, one of the example secure signal converter 101 or the example received signal converter 103 (e.g., depending on which device the example radio architecture is implemented in).

In some embodiments, synthesizer circuitry 1504 may be configured to generate a carrier frequency as the output frequency 1505, while in other embodiments, the output frequency 1505 may be a fraction of the carrier frequency (e.g., one-half the carrier frequency, one-third the carrier frequency). In some embodiments, the output frequency 1505 may be a LO frequency (fLO).

FIG. 1G illustrates a functional block diagram of baseband processing circuitry 1308a in accordance with some embodiments. The baseband processing circuitry 1308a is one example of circuitry that may be suitable for use as the baseband processing circuitry 1308a (FIG. 1D), although other circuitry configurations may also be suitable. Alternatively, the example of FIG. 1F may be used to implement the example BT baseband processing circuitry 1308b of FIG. 1D.

The baseband processing circuitry 1308a may include a receive baseband processor (RX BBP) 1602 for processing receive baseband signals 1509 provided by the radio IC circuitry 1306a-b (FIG. 1D) and a transmit baseband processor (TX BBP) 1604 for generating transmit baseband signals 1511 for the radio IC circuitry 1306a-b. The baseband processing circuitry 1308a may also include control logic 1606 for coordinating the operations of the baseband processing circuitry 1308a.

In some embodiments (e.g., when analog baseband signals are exchanged between the baseband processing circuitry 1308a-b and the radio IC circuitry 1306a-b), the baseband processing circuitry 1308a may include ADC 1610 to convert analog baseband signals 1609 received from the radio IC circuitry 1306a-b to digital baseband signals for processing by the RX BBP 1602. In these embodiments, the baseband processing circuitry 1308a may also include DAC 1612 to convert digital baseband signals from the TX BBP 1604 to analog baseband signals 1611.

In some embodiments that communicate OFDM signals or OFDMA signals, such as through baseband processor 1308a, the transmit baseband processor 1604 may be configured to generate OFDM or OFDMA signals as appropriate for transmission by performing an inverse fast Fourier transform (IFFT). The receive baseband processor 1602 may be configured to process received OFDM signals or OFDMA signals by performing an FFT. In some embodiments, the receive baseband processor 1602 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 1D, in some embodiments, the antennas 1301 (FIG. 1D) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1301 may each include a set of phased-array antennas, although embodiments are not so limited.

Although the radio architecture 1300 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 6^{th} generation mobile networks, 3GPP, long term evolution (LTE), LTE advanced, enhanced data rates for GSM Evolution (EDGE), or the like. Other embodiments may be used in various other devices, systems, and/or networks.

FIGS. 2A-2C illustrate embodiments of channels and subchannels (or resource units) that can facilitate multiple transmissions simultaneously such as a EHT PPDU or a HE PPDU. FIG. 2A illustrates an embodiment of transmissions 2010 between four stations and an AP on four different subchannels (or resource units) of a channel via OFDMA. Grouping subcarriers into groups of resource units is referred to as subchannelization. Subchannelization defines subchannels that can be allocated to stations depending on their channel conditions and service requirements. An OFDMA system may also allocate different transmit powers to different subchannels.

In the present embodiment, the OFDMA STA1, OFDMA STA2, OFDMA STA3, and OFDMA STA4 may represent transmissions on a four different subchannels of the channel. For instance, transmissions 2010 may represent an 80 MHz channel with four 20 MHz bandwidth PPDUs using frequency division multiple access (FDMA). Such embodiments may include, e.g., 1 PPDU per 20 MHz bandwidth, 2 PPDU in a 40 MHz bandwidth, and 4 PPDUs in an 80 MHz bandwidth. As a comparison, FIG. 2B illustrates an embodiment of an orthogonal frequency division multiplexing (OFDM) transmission 2015 for the same channel as FIG. 2A. The OFDM transmission 2015 may use the entire channel bandwidth.

FIG. 2C illustrates an embodiment of a 20-Megahertz (MHz) bandwidth 2020 on a channel that illustrates different resource unit (RU) configurations 2022, 2024, 2026, and 2028. In OFDMA, for instance, an OFDM symbol is constructed of subcarriers, the number of which is a function of the physical layer protocol data unit (PPDU) (also referred to as the PHY frame) bandwidth. There are several subcarrier types: 1) Data subcarriers which are used for data transmission; 2) Pilot subcarriers which are utilized for phase information and parameter tracking; and 3) unused subcarriers which are not used for data/pilot transmission. The unused subcarriers are the direct current (DC) subcarrier, the Guard band subcarriers at the band edges, and the Null subcarriers.

The RU configuration 2022 illustrates an embodiment of nine RUs that each include 26 tones (or subcarriers) for data transmission including the two sets of 13 tones on either side of the DC. The RU configuration 2024 illustrates the same bandwidth divided into 5 RUs including four RUs with 52 tones and one RU with 26 tones about the DC for data transmission. The RU configuration 2026 illustrates the same bandwidth divided into 3 RUs including two RUs with 106 tones and one RU with 26 tones about the DC for data transmission. And the RU configuration 2028 illustrates the same bandwidth divided into 2 RUs including two RUs with 242 tones about the DC for data transmission. Embodiments may be capable of additional or alternative bandwidths such as such as 40 MHz, 80 MHz, 160 MHz, 240 MHz, and 320 MHz.

Many embodiments support RUs of 26-tone RU, 52-tone RU, 106-tone RU, 242-tone RU, 484-tone RU, 996-tone RU, 2×996-tone RU, and 4×996-tone RU. In some embodiments, RUs that are the same size or larger than 242-tone RUs are defined as large size RUs and RUs that are smaller than 242-tones RUs are defined as small size RUs. In some embodiments, small size RUs can only be combined with small size RUs to form small size MRUs. In some embodiments, large size RUs can only be combined with large size RUs to form large size MRUs.

FIG. 2D illustrates an embodiment of a EHT MU PPDU 2100 in the form of an 802.11, orthogonal frequency division multiple access (OFDMA) packet on a 20 MHz channel of, e.g., a 2.4 GHz link, a 5 GHz link, a 6 GHz link, or any other frequency. In some embodiments, the baseband processing circuitry, such as the baseband processing circuitry 1218 in FIG. 1C, may transmit a EHT MU PPDU 2100 transmission on the 6 GHz carrier frequency, optionally with beamforming. In some embodiments, the EHT MU PPDU 2100 may comprise a MAC association request or response frame, an MAC reassociation request or response frame, another MAC frame that may comprise a TWT element to establish an agreement for a rTWT SP, and/or the like.

The EHT MU PPDU 2100 may comprise a legacy preamble 2110 to notify other devices in the vicinity of the source STA, such as an AP STA, that the 20 MHz channel is in use for a duration included in the legacy preamble 2110. The legacy preamble 2110 may comprise one or more short training fields (L-STFs), one or more long training fields (L-LTFs), and one or more signal fields (L-SIG and RL-SIG).

The EHT MU PPDU 2100 may also comprise a EHT preamble 2120 to identify a subsequent 6 GHz carrier link transmission as well as the STAs that are the targets of the transmission. Similarly, the EHT preamble 2120 may comprise one or more short training fields (EHT-STFs), one or more long training fields (EHT-LTFs), and one or more signal fields (EHT-SIG).

After the EHT preamble 2120, the EHT MU PPDU 2100 may comprise a data portion 2140 that includes a single user (SU) or multiple user (MU) packet. FIG. 2D illustrates the MU packet with four designated RUs. Note that the number and size of the RUs may vary between packets based on the number of target STAs and the types of payloads in the data portions 2140.

FIG. 2E depicts another embodiment of the MAC Management frame in the EHT MU PPDU 2200. In some embodiments, the EHT MU PPDU 2200 may be a frame format used for a DL transmission to one or more STAs. In the EHT MU PPDU 2200, the MAC management frame may comprise two legacy (L) short training fields (STFs) with an 8 microseconds duration each, a legacy (L) signal (SIG) field with a four-microsecond duration, a repeated, legacy signal field (RL-SIG) with a 4-microsecond duration, and a U-SIG with 2 symbols having a 4 microsecond duration each. The EHT MU PPDU 2200 format may also comprise a EHT signal field (EHT-SIG) with 2 symbols at 4 microseconds each, an EHT STF, a number of EHT-LTFs, a data field, and a packet extension (PE) field. In some embodiments, the data field may comprise a MAC management frame such as a beacon frame comprising a broadcast parameter set field to broadcast information about a rTWT SP.

As illustrated in FIG. 2F, the data field of the EHT MU PPDU 2200 may comprise a MAC management frame 2210 such as a MAC beacon frame, a MAC association request or response frame, a MAC reassociation request or response frame, a MAC probe request or response frame, another MAC frame comprising one or more TWT elements, and/or the like. The data field may comprise an MPDU (PSDU) of the MAC management frame. The MAC management frame may comprise a TWT element 2346 shown in FIG. 2M.

In some embodiments, the MAC management frame may include a 2 octet frame control field, a 2 octet duration field, a 6 octet address 1 field, a 6 octet address 2 field, a 6 octet address 3 field, a 2 octet sequence control field, and a 0 or 4 octet high-throughput (HT) control field, in the MAC header. The MAC management frame may also include a variable length frame body field, and a 4-octet frame check sequence (FCS) field comprising a value, such as a 32-bit cyclic redundancy code (CRC), to check the validity of and/or correct preceding frame.

The Duration field may be the time, in microseconds, required to transmit the pending management frame, plus, in some embodiments, one acknowledgement (ACK) frame and one or more short interframe spaces (SIFSs). If the calculated duration includes a fractional microsecond, that value may be rounded up to the next higher integer.

The address 1 field of the MAC management frame may comprise the address of the intended receiver such as sensing responder. The address 2 field may be the address the transmitter such as a sensing initiator that transmitted the MAC management frame. The address 3 field may be the basic service set identifier (BSSID) of the sensing initiator.

The HT control field may be present in management frames as determined by the +HTC subfield of the frame control field. The frame body may include one or more fields and/or elements such as the fields and/or elements depicted in FIGS. 2M-2P.

FIG. 2G depicts an embodiment of EDCA mechanism timing relationships 2300. An example showing the relationship between AIFS, AIFSN, DIFS, and slot times immediately following a medium busy condition (and assuming that medium busy condition was not caused by a frame in error) is shown in FIG. 10-29 (EDCA mechanism timing relationships). In this case, with AIFSN=2, the EDCAF may decrement the backoff counter for the first time at 2×aSlotTime following the TxSIFS (where TxSIFS is the time at which the MAC responds to the end of the medium busy condition if it is going to respond “after SIFS”). If, in this example, the backoff counter contained a value of 1 at the time the medium became idle, transmission would start as a result of an EDCA TXOP on-air at a time aSIFSTime+3×aSlotTime following the end of the medium busy condition.

A STA shall save the TXOP holder address for the BSS in which it is associated. The TXOP holder address is the MAC address from the Address 2 field of the frame that initiated a frame exchange sequence except if this is a clear-to-send (CTS) frame, in which case the TXOP holder address is the Address 1 field. If the TXOP holder address is obtained from a Control frame, a very high throughput (VHT) STA or high efficiency (HE) STA shall save the nonbandwidth signaling transmitter address (TA) obtained from the Address 2 field. If a non-VHT non-HE STA receives a ready-to-send (RTS) frame with the receiver address (RA) matching the MAC address of the STA and the MAC address in the TA field in the RTS frame matches the saved TXOP holder address, then the STA shall send the CTS frame after SIFS, without regard for, and without resetting, its network allocation vector (NAV). If a VHT STA or HE STA receives an RTS frame with the RA matching the MAC address of the STA and the nonbandwidth signaling TA obtained from the Address 2 field in the RTS frame matches the saved TXOP holder address, then the STA shall send the CTS frame after SIFS, without regard for, and without resetting, its NAV. If a China millimeter wave multi-gigabit (CMMG) STA receives an RTS frame with the RA matching the MAC address of the STA and the TA value obtained from the Address 2 field in the RTS frame matches the saved TXOP holder address, then the STA shall send the CTS frame after SIFS, without regarding for, and without resetting its NAV. When a STA receives a frame addressed to it that requires an immediate response, except for RTS and Trigger frames, it shall transmit the response independent of its NAV. The saved TXOP holder address shall be cleared when the NAV is reset or when the NAV counts down to 0.

During an EDCA TXOP, the Address 2 field excluding the Individual/Group bit of all Control frames sent by an HE STA that is a TXOP holder and carried in a PPDU that is not an HE MU PPDU shall be set to the same address value. Note that a time unit (TU) is a measurement of time equal to 1024 microseconds (μs).

FIG. 2H depicts an embodiment of a backoff procedure for a contention period 2302. The busy medium may represent a medium that has an active TxOP. At the end of the TxOP, which may occur prior to the start of a rTWT SP, an AP MLD and/or one or more non-AP MLDs that are members of the rTWT SP may wait an IFS such as a PIFS or a DIFS and then cause transmission of a defer signal. Any STAs that perform a CCA during the defer signal may determine that the medium is busy and may defer or wait for the channel to become idle or until an expiration of a time period associated with the defer signal such a NAV.

FIG. 2I depicts an embodiment of an individual, trigger-enabled TWT operation 2320, where the AP is the TWT responding STA and STA 1 and STA 2 are the TWT requesting STAs. In this example, STA 1 sends a TWT request to the TWT responding STA to setup a trigger-enabled TWT agreement. The TWT responding STA accepts the TWT agreement with STA 1 and confirms the acceptance in the TWT response sent to STA 1. Subsequently, the TWT responding STA sends an unsolicited TWT response to STA 2 to set up a trigger-enabled TWT agreement with STA 2. Both these TWT agreements are set up as announced TWTs. During the trigger-enabled TWT SP, the TWT responding STA sends a Basic Trigger frame to which the TWT requesting STAs indicate that they are awake during the TWT SP. STA 1 indicates that it is awake by sending a power save (PS)-Poll frame, and STA 2 indicates that it is awake by sending a QoS Null frame in response to the Basic Trigger frame. STA 1 and STA 2 receive their DL buffered units (BUs) in a subsequent exchange with the TWT responding STA and go to doze state outside of this TWT SP. In some embodiments, the trigger-enabled TWT SP is a rTWT SP based on restricted parameters in the TWT parameter information field of the TWT element in the TWT request and TWT agreement.

FIG. 2J depicts an embodiment of a timeline 2340 for prioritized access with an AP, a member STA, and a non-member STA. The timeline 2340 shows actions and/or statuses of the AP and the STAs as time progresses from left to right. In many embodiments, this timeline is not to scale but shows progression of the prioritized access for the AP and the STAs. The first occurrence on the timeline is a TxOP that completes prior to an rTWT SP. After the TxOP ends, a contention period starts for the rTWT SP. In other embodiments, the contention period for the rTWT SP may start at the start of the rTWT SP.

In this embodiment, the contention period begins a margin time prior to the start of the rTWT SP and overlaps the rTWT SP. An IFS after the start of the contention period, the defer logic circuitry of the AP and the member STA both cause transmission of a defer signal. In many embodiments, the defer signals transmitted from the AP and the member STA are the same. In other embodiments, the defer signal from the AP may have a different configuration than the defer signal of the member STA. Furthermore, the AP and the member STA may transmit the defer signals concurrently or simultaneously.

The non-member STA performs a CCA and determines that the medium is busy based on detection of the energy of defer signals and/or based on receiving and interpreting a PHY header or a MAC header of the defer signals. In response to detection of the defer signals, the non-member STA may defer access to the medium for a defer time. After the defer time, the non-member STA may perform a CCA and, if the medium is idle, perform a backoff procedure with a backoff counter by decrementing a backoff count.

After transmission of the defer signals the AP and the member STA may determine backoff counts and begin to decrement the backoff counts. In the present embodiment, the backoff count for the AP expires prior to the backoff count for the member STA so the AP gains access to the medium to transmit AC_PL data queued for DL to a STA such as the member STA or the non-member STA.

The member STA may reset the backoff count when during the transmission of the AC_PL in response to detecting that the medium is busy. After the AC_PL data transmission ends, the member STA may determine that the medium is idle and may begin to decrement a backoff count. After the backoff count expires, the member STA may UL AC_PL data to the AP.

The non-member STAA may detect the AC_PL data transmission from the member STA, stop the backoff counter, and determine that the medium is busy.

FIG. 2K depicts an embodiment of a TWT setup frame 2342, which is an action frame. The TWT setup frame 2342 is sent by a STA to request the setup of a TWT SP and it is sent by a responding STA to indicate the status of a requested TWT SP. The TWT setup frame 2342 may comprise an action field and other fields. The action field may comprise a category field, an unprotected sub-1 GHz (S1G) Action field, a dialog token field, and one or more TWT elements. Each of the one or more TWT elements may comprise a TWT parameter information field and the TWT parameter information field may comprise a restricted parameters field to identify the TWT SP as a rTWT SP. The restricted parameters field may comprise a mode field to identify a mode of a trigger-enabled rTWT SP.

FIG. 2L depicts an embodiment of a TWT tear down frame 2344, which is an action frame. The TWT tear down frame 2344 is sent by a STA to request the teardown of a TWT agreement and is transmitted by either STA of an existing TWT agreement. The TWT tear down frame 2344 may comprise an action field and other fields. The action field may comprise a category field, an unprotected sub-1 GHz (S1G) Action field, and TWT flow field. The TWT flow field may comprise a TWT flow ID field to identify the rTWT SP.

FIG. 2O depicts an embodiment of a TWT element 2346. The TWT element 2346 may comprise an element ID field to identify the element as TWT element, a length field to identify a length of the TWT element, a control field, and a TWT parameter information field. The control field my comprise fields in the control field 2348 shown in FIG. 2N. The TWT parameter information field may comprise a single Individual TWT Parameter Set field comprising a request type field, a target wake time field, a TWT group assignment field, a nominal minimum TWT wake duration field, a TWT wake interval mantissa field, a TWT channel field, and an optional null data packet (NDP) paging field, if the Broadcast subfield in the Control field is 0. The TWT Parameter Set field may comprise one or more Broadcast TWT Parameter Set fields comprising a request type field, a target wake time field, a nominal minimum TWT wake duration field, a TWT wake interval mantissa field, and a broadcast TWT info field, if the Broadcast subfield of the Control field is 1. The number of Broadcast TWT Parameter Set fields present is determined by the values of the Last Broadcast Parameter Set subfields of the Request Type fields.

FIG. 2N depicts an embodiment of a control field 2348 of a TWT parameters information field such as the TWT parameters information field in the TWT element 2346. The control field 2348 may comprise a NDP paging indicator field, a responder PM mode field, a negotiation type, a TWT information frame disabled field, a link ID bitmap present field, and an aligned TWT field. The NDP Paging field is present if the NDP Paging Indicator subfield is equal to 1; otherwise, the NDP Paging field is not present.

The Responder PM Mode subfield indicates the power management mode. The Negotiation Type subfield indicates whether the information included in the TWT element is for the negotiation of parameters of broadcast or individual TWT(s) or a Wake TBTT interval. The MSB of the Negotiation Type subfield is the Broadcast field.

The TWT Information Frame Disabled subfield is set to 1 to indicate that the reception of TWT Information frames is disabled by the STA; otherwise, it is set to 0. The Wake Duration Unit subfield indicates the unit of the Nominal Minimum TWT Wake Duration field. The Wake Duration Unit subfield is set to 0 if the unit is 256 microseconds (s) and is set to 1 if the unit is a TU. A non-HE STA sets the Wake Duration Unit subfield to 0.

If the Broadcast field of the Negotiation Type subfield is 1, then one or more broadcast TWT parameter sets are contained in the TWT element. If the Broadcast field of the Negotiation Type subfield is 0, then only one Individual TWT parameter set is contained in the TWT element. An S1G STA sets the Negotiation Type subfield to 0.

A TWT element that has the Broadcast field in the Control field set to 1 is referred to as broadcast TWT element. The Negotiation Type subfield determines the interpretation of the Target Wake Time, TWT Wake Interval Mantissa, and TWT Wake Interval Exponent subfields of the TWT element.

FIGS. 2O-2P illustrates an example of a PPDU 2460 with a MAC management frame that may be transmitted by an AP MLD to a non-AP MLD, or vice vera. In FIG. 2O, the PPDU 2460 format may be used for a transmission of an association request/response frame, a reassociation request/response frame, or a probe request/response frame.

The PPDU 2460 format may comprise an OFDM PHY preamble, an OFDM PHY header, a PSDU, tail bits, and pad bits. The PHY header may contain the following fields: length, rate, a reserved bit, an even parity bit, and the service field. in terms of modulation, the length, rate, reserved bit, and parity bit (with 6 zero tail bits appended) may constitute a separate single OFDM symbol, denoted signal, which is transmitted with the combination of BPSK modulation and a coding rate of R=1/2.

The PSDU (with 6 zero tail bits and pad bits appended), denoted as data, may be transmitted at the data rate described in the rate field and may constitute multiple OFDM symbols. The tail bits in the signal symbol may enable decoding of the rate and length fields immediately after reception of the tail bits. The rate and length fields may be required for decoding the data field of the PPDU.

In FIG. 2P, the data field of the PPDU may comprise an MPDU such as a MAC management frame 2470. The MAC management frame 2470 may include a 2-octet frame control field, a 2-octet duration field, a 6 octet RA field, and a 4-octet frame check sequence field comprising a value, such as a 32-bit CRC, to check the validity of and/or correct preceding frame.

In several embodiments, the value of the addr1 field of the MAC management frame is set to the recipient address (RA) of the MAC management frame 2470 such as a collocated AP MLD.

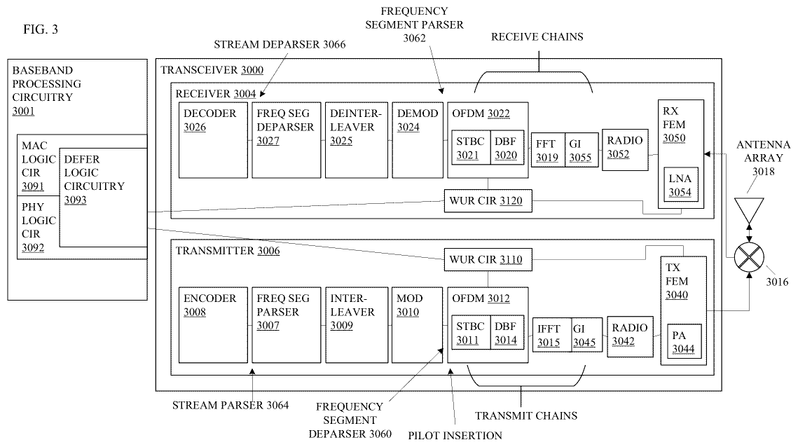

FIG. 3 depicts an embodiment of an apparatus to generate, transmit, receive, and interpret or decode PHY frames and MAC frames. The apparatus comprises a transceiver 3000 coupled with baseband processing circuitry 3001. The baseband processing circuitry 3001 may comprise a MAC logic circuitry 3091 and PHY logic circuitry 3092 as well as defer logic circuitry 3093. The defer logic circuitry 3093 may perform the functionality discussed herein for prioritized access. In other embodiments, the baseband processing circuitry 3001 may be included on the transceiver 3000.

The MAC logic circuitry 3091 and PHY logic circuitry 3092 may comprise code executing on processing circuitry of a baseband processing circuitry 3001; circuitry to implement operations of functionality of the MAC or PHY; or a combination of both. In the present embodiment, the MAC logic circuitry 3091 and PHY logic circuitry 3092 may comprise defer logic circuitry 3093 to transition links of a non-AP MLD from a first collocated AP MLD affiliated with a non-collocated AP MLD to a second collocated AP MLD affiliated with the non-collocated AP MLD. For example, the defer logic circuitry of the non-AP MLD may implement defer logic circuitry to prepare for the link transition for one or more STAs of the non-AP MLD, add new links between the one or more STAs of the non-AP MLD and one or more AP STAs of the second AP collocated MLD, enablement of the links between the one or more STAs of the non-AP MLD and one or more AP STAs of the second AP collocated MLD, disablement of the links between the one or more STAs of the non-AP MLD and one or more AP STAs of the first AP collocated MLD, and link removal of the links between the one or more STAs of the non-AP MLD and one or more AP STAs of the first AP collocated MLD.

The MAC logic circuitry 3091 may determine a frame such as a MAC management frame and the PHY logic circuitry 3092 may determine the physical layer protocol data unit (PPDU) by prepending the frame, also called a MAC protocol data unit (MPDU), with a physical layer (PHY) preamble for transmission of the MAC management frame via the antenna array 3018. The PHY logic circuitry 3092 may cause transmission of the MAC management frame in the PPDU.

The transceiver 3000 comprises a receiver 3004 and a transmitter 3006. Embodiments have many different combinations of modules to process data because the configurations are deployment specific. FIG. 3 illustrates some of the modules that are common to many embodiments. In some embodiments, one or more of the modules may be implemented in circuitry separate from the baseband processing circuitry 3001. In some embodiments, the baseband processing circuitry 3001 may execute code in processing circuitry of the baseband processing circuitry 3001 to implement one or more of the modules.

In the present embodiment, the transceiver 3000 also includes WUR circuitry 3110 and 3120. The WUR circuitry 3110 may comprise circuitry to use portions of the transmitter 3006 (a transmitter of the wireless communications I/F such as wireless communications I/Fs 1216 and 1246 of FIG. 1C) to generate a WUR packet. For instance, the WUR circuitry 3110 may generate, e.g., an OOK signal with OFDM symbols to generate a WUR packet for transmission via the antenna array 3018. In other embodiments, the WUR may comprise an independent circuitry that does not use portions of the transmitter 3006.

Note that a MLD such as the AP MLD 1210 in FIG. 1C may comprise multiple transmitters to facilitate concurrent transmissions on multiple contiguous and/or non-contiguous carrier frequencies.

The transmitter 3006 may comprise one or more of or all the modules including an encoder 3008, a stream deparser 3066, a frequency segment parser 3007, an interleaver 3009, a modulator 3010, a frequency segment deparser 3060, an OFDM 3012, an Inverse Fast Fourier Transform (IFFT) module 3015, a GI module 3045, and a transmitter front end 3040. The encoder 3008 of transmitter 3006 receives and encodes a data stream destined for transmission from the MAC logic circuitry 3091 with, e.g., a binary convolutional coding (BCC), a low-density parity check coding (LDPC), and/or the like. After coding, scrambling, puncturing and post-FEC (forward error correction) padding, a stream parser 3064 may optionally divide the data bit streams at the output of the FEC encoder into groups of bits. The frequency segment parser 3007 may receive data stream from encoder 3008 or streams from the stream parser 3064 and optionally parse each data stream into two or more frequency segments to build a contiguous or non-contiguous bandwidth based upon smaller bandwidth frequency segments. The interleaver 3009 may interleave rows and columns of bits to prevent long sequences of adjacent noisy bits from entering a BCC decoder of a receiver.

The modulator 3010 may receive the data stream from interleaver 3009 and may impress the received data blocks onto a sinusoid of a selected frequency for each stream via, e.g., mapping the data blocks into a corresponding set of discrete amplitudes of the sinusoid, or a set of discrete phases of the sinusoid, or a set of discrete frequency shifts relative to the frequency of the sinusoid. In some embodiments, the output of modulator 3010 may optionally be fed into the frequency segment deparser 3060 to combine frequency segments in a single, contiguous frequency bandwidth of, e.g., 320 MHz. Other embodiments may continue to process the frequency segments as separate data streams for, e.g., a non-contiguous 160+160 MHz bandwidth transmission.

After the modulator 3010, the data stream(s) are fed to an OFDM 3012. The OFDM 3012 may comprise a space-time block coding (STBC) module 3011, and a digital beamforming (DBF) module 3014. The STBC module 3011 may receive constellation points from the modulator 3010 corresponding to one or more spatial streams and may spread the spatial streams to a greater number of space-time streams. Further embodiments may omit the STBC.

The OFDM 3012 impresses or maps the modulated data formed as OFDM symbols onto a plurality of orthogonal subcarriers, so the OFDM symbols are encoded with the subcarriers or tones. The OFDM symbols may be fed to the DBF module 3014. Generally, digital beam forming uses digital signal processing algorithms that operate on the signals received by, and transmitted from, an array of antenna elements. Transmit beamforming processes the channel state to compute a steering matrix that is applied to the transmitted signal to optimize reception at one or more receivers. This is achieved by combining elements in a phased antenna array in such a way that signals at particular angles experience constructive interference while others experience destructive interference.

The IFFT module 3015 may perform an inverse discrete Fourier transform (IDFT) on the OFDM symbols to map on the subcarriers. The guard interval (GI) module 3045 may insert guard intervals by prepending to the symbol a circular extension of itself. The GI module 3045 may also comprise windowing to optionally smooth the edges of each symbol to increase spectral decay.

The output of the GI module 3045 may enter the radio 3042 to convert the time domain signals into radio signals by combining the time domain signals with subcarrier frequencies to output into the transmitter front end module (TX FEM) 3040. The transmitter front end 3040 may comprise a with a power amplifier (PA) 3044 to amplify the signal and prepare the signal for transmission via the antenna array 3018. In many embodiments, entrance into a spatial reuse mode by a communications device such as a station or AP may reduce the amplification by the PA 3044 to reduce channel interference caused by transmissions.

The transceiver 3000 may also comprise duplexers 3016 connected to antenna array 3018. The antenna array 3018 radiates the information bearing signals into a time-varying, spatial distribution of electromagnetic energy that can be received by an antenna of a receiver. In several embodiments, the receiver 3004 and the transmitter 3006 may each comprise its own antenna(s) or antenna array(s).

The transceiver 3000 may comprise a receiver 3004 for receiving, demodulating, and decoding information bearing communication signals. The receiver 3004 may comprise a receiver front-end module (RX FEM) 3050 to detect the signal, detect the start of the packet, remove the carrier frequency, and amplify the subcarriers via a low noise amplifier (LNA) 3054 to output to the radio 3052. The radio 3052 may convert the radio signals into time domain signals to output to the GI module 3055 by removing the subcarrier frequencies from each tone of the radio signals.

The receiver 3004 may comprise a GI module 3055 and a fast Fourier transform (FFT) module 3019. The GI module 3055 may remove the guard intervals and the windowing and the FFT module 3019 may transform the communication signals from the time domain to the frequency domain.

The receiver 3004 may also comprise an OFDM 3022, a frequency segment parser 3062, a demodulator 3024, a deinterleaver 3025, a frequency segment deparser 3027, a stream deparser 3066, and a decoder 3026. An equalizer may output the weighted data signals for the OFDM packet to the OFDM 3022. The OFDM 3022 extracts signal information as OFDM symbols from the plurality of subcarriers onto which information-bearing communication signals are modulated.

The OFDM 3022 may comprise a DBF module 3020, and an STBC module 3021. The received signals are fed from the equalizer to the DBF module 3020. The DBF module 3020 may comprise algorithms to process the received signals as a directional transmission directed toward to the receiver 3004. And the STBC module 3021 may transform the data streams from the space-time streams to spatial streams.

The output of the STBC module 3021 may enter a frequency segment parser 3062 if the communication signal is received as a single, contiguous bandwidth signal to parse the signal into, e.g., two or more frequency segments for demodulation and deinterleaving.

The demodulator 3024 demodulates the spatial streams. Demodulation is the process of extracting data from the spatial streams to produce demodulated spatial streams. The deinterleaver 3025 may deinterleave the sequence of bits of information. The frequency segment deparser 3027 may optionally deparse frequency segments as received if received as separate frequency segment signals or may deparse the frequency segments determined by the optional frequency segment parser 3062. The decoder 3026 decodes the data from the demodulator 3024 and transmits the decoded information, the MPDU, to the MAC logic circuitry 3091.

The MAC logic circuitry 3091 may parse the MPDU based upon a format defined in the communications device for a frame to determine the particular type of frame by determining the type value and the subtype value. The MAC logic circuitry 3091 may then interpret the remainder of MPDU.

While the description of FIG. 3 focuses primarily on a single spatial stream system for simplicity, many embodiments are capable of multiple spatial stream transmissions and use parallel data processing paths for multiple spatial streams from the PHY logic circuitry 3092 through to transmission. Further embodiments may include the use of multiple encoders to afford implementation flexibility.

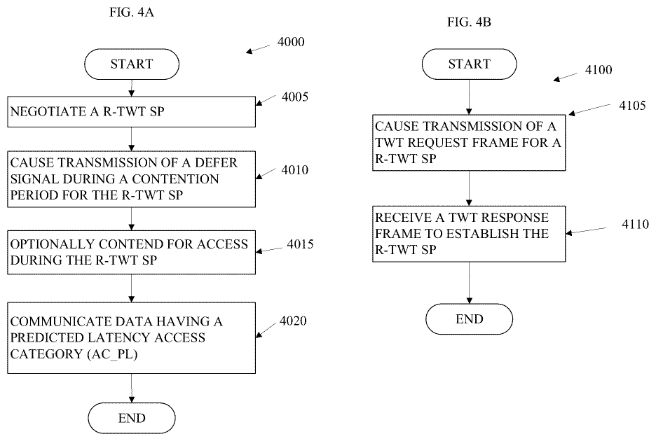

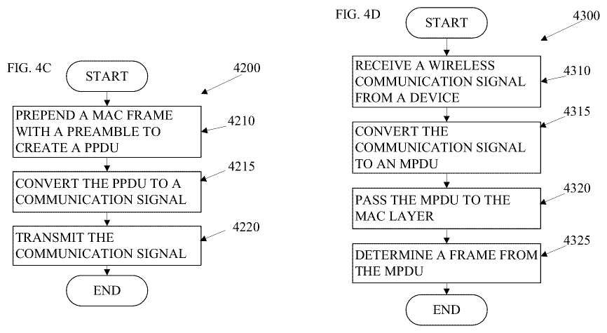

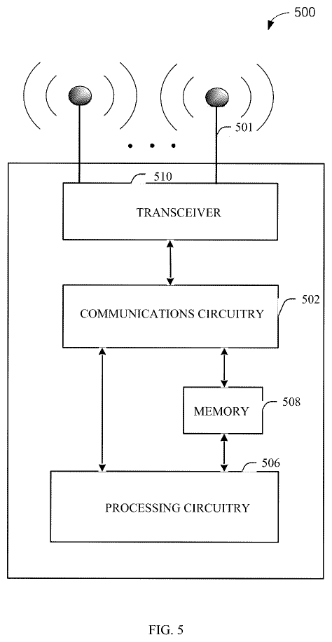

FIG. 4A depicts an embodiment of a flowchart of a process 4000 to implement defer logic circuitry such as the defer logic circuitry discussed in conjunction with FIGS. 1-3. At element 4005, defer logic circuitry of an AP STA or one or more non-AP STAs may receive and parse (TWT responder), or generate and cause transmission (TWT requestor(s)) of a TWT request frame comprising a TWT element with TWT parameters in a TWT parameter information field to define a rTWT SP (element 4005). The TWT request frame may comprise an association request frame, a reassociation request frame, a probe request frame, a TWT setup frame, or another MAC frame that comprises at least one TWT element. The TWT parameters may comprise individual TWT parameters in an individual parameter set field.

In some embodiments, the AP STA may cause transmission of a beacon frame comprising a TWT element with a broadcast TWT parameter set for the rTWT SP and the non-AP STA may transmit a TWT request to establish an agreement to become a member of the rTWT SP. In such embodiments, the AP STA may respond to the request with a TWT response to accept or reject membership of the non-AP STA in the rTWT SP.

After receipt of the TWT request, a TWT responder (the AP STA or one or more non-AP STAs) may respond to the TWT request with a TWT response that includes a TWT element. The TWT element in the response may accept the TWT parameters of a TWT parameter information field in a TWT element of the TWT request, offer an alternative set of TWT parameters, or reject the TWT request. The TWT response frame may comprise an association response frame, a reassociation response frame, a probe response frame, a TWT setup frame, or another MAC frame that comprises at least one TWT element.

After negotiating the rTWT SP, the AP STA and the one or more non-AP STAs that are members of the rTWT SP may determine or detect an idle channel (or medium or media that comprises more than one channels), and wait e.g., a PIFS or DIFS after the channel becomes idle, and transmit a defer signal on the channel (assuming the channel does not become busy again during the PIFS or DIFS) (element 4010). In some embodiments, the AP STA and the one or more non-AP STAs may start the wait or delay of the PIFS or DIFS during a contention period that begins at the start of the rTWT SP. In some embodiments, the AP STA and the one or more non-AP STAs may start the wait or delay of the PIFS or DIFS during a contention period that begins a margin time before the start of the rTWT SP. In some embodiments, such as embodiments in which the rTWT SP comprises a trigger-enabled rTWT SP, only the AP STA may send the defer signal.

Once the defer signal transmits, the AP STA and/or the one or more non-AP STAs may contend for the rTWT SP (element 4015). In many embodiments, the contention may comprise determination of a backoff count that may include or be based on a random number, a pseudorandom number, and/or the like. In such embodiments, each of the AP STA and/or the one or more non-AP STAs may decrement their individually determined counts. The STA that decrements the backoff count to zero first may cause transmission of the AC_PL data on the channel (element 4020). For instance, the AP STA may determine a smaller backoff count than the backoff counts of the one or more non-AP STAs so may decrement the smaller count to zero sooner than the one or more non-AP STAs.

In many embodiments, the defer logic circuitry of the AP STA and the non-AP STAs that are members of the rTWT SP may impose rules to limit access to the channel by the AP STA and/or the one or more non-AP STAs. For example, in some embodiments, a set of rules imposed by the defer logic circuitry may cause the AP STA to advertise the rTWT SP in a beacon as a trigger-enabled rTWT SP, send a defer signal an IFS (e.g., PIFS or DIFS) after detection of an idle channel or determination of the idle channel. In some embodiments, the contention period may begin a margin time prior to the rTWT SP. In some embodiments, the contention period may begin at the start of the rTWT SP. Furthermore, in some embodiments, the AP STA may contend for the channel. In other words, the one or more STAs that are members of the rTWT SP may not cause transmission of the defer signal and may not contend during the rTWT SP.

As another example, the defer logic circuitry of the one or more AP STAs and the AP STA may cause the one or more non-AP STAs to cause transmission of the defer signal an IFS after determination that the channel is idle during a contention period that may start at the start of a non-triggered rTWT SP or a margin time prior to the start time of the non-triggered rTWT-SP. In such embodiments, the AP STA may not send a defer signal or contend during the non-triggered rTWT SP.

As another example, in some embodiments, the defer logic circuitry of the AP STA and the one or more non-AP STAs that are members of a trigger-enabled rTWT, may allow both the AP STA and the non-AP STAs to cause transmission of the defer signal during a contention period after an IFS (e.g., a PIFS or DIFS) from a determination that the channel is idle. In such embodiments, the defer logic circuitry of the AP STA and the one or more non-AP STAs may determine a mode of the trigger-enabled rTWT SP. In such embodiments, the AP STA and the one or more non-AP STAs may refer to an existing agreement for the triggered rTWT SP to determine if the trigger-enabled rTWT SP is a mode 1 or a mode 2. For the mode 1 trigger-enabled rTWT SP, the defer logic of the AP STA may cause the AP STA to contend for channel during the rTWT SP and the defer logic circuitry of the one or more non-AP STAs may cause the one or more non-AP STAs to abstain from contending for the channel during the trigger-enabled rTWT SP.

For the mode 2 trigger-enabled rTWT SP, the defer logic of the AP STA may cause the AP STA to contend for channel during the rTWT SP and the defer logic circuitry of the one or more non-AP STAs may cause the one or more non-AP STAs to contend for the channel during the trigger-enabled rTWT SP. In many embodiments, the agreement for the mode may be located in a mode field of a restricted parameters field of a TWT parameter information field of a TWT parameter information element of a TWT request and/or a TWT response during negotiation of the triggered rTWT SP.

FIG. 4B depicts another embodiment of a flowchart of a process 4100 to implement defer logic circuitry such as the defer logic circuitry discussed in FIGS. 1-3. At element 4105, defer logic circuitry of a STA may generate and cause transmission of a TWT request frame for negotiating a rTWT SP (element 4105). The STA may comprise an AP STA or a non-AP STA. The defer logic circuitry of the STA may, thereafter, receive a TWT response frame. The TWT response frame may accept, accept with modifications, or reject the rTWT SP. In many embodiments, a non-AP STA that joins a rTWT SP may transmit a defer signal and/or contend during the rTWT SP if the non-AP STA has data with an access category of AC_PL queued for transmission either within the non-AP STA or buffered by an AP STA.

In many embodiments, during negotiation for an rTWT SP, the STAs may transmit more than one TWT elements to negotiate more than one rTWT SPs. Each TWT element may include parameters to define the TWT SP as an rTWT SP and may also include parameters to define the rTWT SP as a one-time rTWT SP, as a periodic rTWT SP with a finite number of repetitions or a finite duration, or as a periodic rTWT SP with no specified number of repetitions nor duration. In the latter case, the STA may have to terminate the rTWT SP with a TWT teardown frame. In other words, to end a periodic rTWT SP that is not limited to a finite number of repetitions, the STA may cause transmission of the TWT teardown frame to terminate the periodic rTWT SP.

FIGS. 4C-D depict embodiments of flowcharts 4200 and 4300 to transmit, receive, and interpret communications with a frame. Referring to FIG. 4C, the flowchart 4200 may begin with receiving an MU frame from the wireless communications I/F 1216 of the AP MLD 1210 by the wireless communications I/Fs (such as wireless communications I/F 1246 of the MLD 1230, MLD 1290, MLD 1292, and MLD 1296 as shown in FIG. 1C. The MAC logic circuitry, such as the MAC logic circuitry 3091 in FIG. 1C, of each MLD of MLD 1230, MLD 1290, MLD 1292, and MLD 1296 may operate in conjunction with defer logic circuitry 3093 to generate a management frame to transmit to the AP MLD 1210 as a (re)association request frame or a probe request frame and may pass the frame as an MAC protocol data unit (MPDU) to a PHY logic circuitry such as the PHY logic circuitry 3092 in FIG. 1C as a PSDU to include in a PHY frame. The PHY logic circuitry may also encode and transform the PSDU into OFDM symbols for transmission to the AP MLD 1210. The PHY logic circuitry may generate a preamble to prepend the PHY service data unit (PSDU) (the MPDU) to form a PHY protocol data unit (PPDU) for transmission (element 4210).

A physical layer device such as the transmitter 3006 in FIG. 3 or the wireless network interfaces 1222 and 1252 in FIG. 1A may convert the PPDU to a communication signal via a radio (element 4215). The transmitter may then transmit the communication signal via the antenna coupled with the radio (element 4220).

Referring to FIG. 4D, the flowchart 4300 begins with a receiver of a device such as the receiver 3004 in FIG. 3 receiving a communication signal via one or more antenna(s) such as an antenna element of antenna array 3018 (element 4310). The receiver may convert the communication signal into an MPDU in accordance with the process described in the preamble (element 4315). More specifically, the received signal is fed from the one or more antennas to a DBF such as the DBF 220. The DBF transforms the antenna signals into information signals. The output of the DBF is fed to OFDM such as the OFDM 3022 in FIG. 3. The OFDM extracts signal information from the plurality of subcarriers onto which information-bearing signals are modulated. Then, the demodulator such as the demodulator 3024 demodulates the signal information via, e.g., BPSK, 16-QAM (quadrature amplitude modulation), 64-QAM, 256-QAM, 1024-QAM, or 4096-QAM with a forward error correction (FEC) coding rate (1/2, 2/3, 3/4, or 5/6). And the decoder such as the decoder 3026 decodes the signal information from the demodulator via, e.g., BCC or LDPC, to extract the MPDU and pass or communicate the MPDU to MAC layer logic circuitry such as MAC logic circuitry 3091 (element 4320).

When received at the MAC layer circuitry, the MPDU may be a MAC Service Data Unit (MSDU). The MAC logic circuitry in conjunction with defer logic circuitry may determine frame field values from the MSDU (MPDU from PHY) (element 4325) such as the management frame fields in the management frame shown in FIG. 2F. For instance, the MAC logic circuitry may determine frame field values such as the type and subtype field values to determine that the MAC frame is the management frame and, more specifically, an association request frame, a reassociation request frame, an association response frame, a reassociation response frame, a probe request frame, and/or a probe response frame.

FIG. 5 shows a functional diagram of an exemplary communication station 500, in accordance with one or more example embodiments of the present disclosure. In one embodiment, FIG. 5 illustrates a functional block diagram of a communication station that may be suitable for use as an AP MLD 1005 (FIG. 1A) or a user device 1028 (FIG. 1A) in accordance with some embodiments. The communication station 500 may also be suitable for use as other user device(s) 1020 such as the user devices 1024 and/or 1026. The user devices 1024 and/or 1026 may include, e.g., a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 500 may include communications circuitry 502 and a transceiver 510 for transmitting and receiving signals to and from other communication stations using one or more antennas 501. The communications circuitry 502 may include circuitry that can operate the physical layer (PHY) communications and/or medium access control (MAC) communications for controlling access to the wireless medium, and/or any other communications layers for transmitting and receiving signals. The communication station 500 may also include processing circuitry 506 and memory 508 arranged to perform the operations described herein. In some embodiments, the communications circuitry 502 and the processing circuitry 506 may be configured to perform operations detailed in the above figures, diagrams, and flows.

In accordance with some embodiments, the communications circuitry 502 may be arranged to contend for a wireless medium and configure frames or packets for communicating over the wireless medium. The communications circuitry 502 may be arranged to transmit and receive signals. The communications circuitry 502 may also include circuitry for modulation/demodulation, upconversion/downconversion, filtering, amplification, etc. In some embodiments, the processing circuitry 506 of the communication station 500 may include one or more processors. In other embodiments, two or more antennas 501 may be coupled to the communications circuitry 502 arranged for sending and receiving signals. The memory 508 may store information for configuring the processing circuitry 506 to perform operations for configuring and transmitting message frames and performing the various operations described herein. The memory 508 may include any type of memory, including non-transitory memory, for storing information in a form readable by a machine (e.g., a computer). For example, the memory 508 may include a computer-readable storage device, read-only memory (ROM), random-access memory (RAM), magnetic disk storage media, optical storage media, flash-memory devices and other storage devices and media.

In some embodiments, the communication station 500 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 500 may include one or more antennas 501. The antennas 501 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 500 may include one or more of a keyboard, a display, a non-volatile memory port, multiple antennas, a graphics processor, an application processor, speakers, and other mobile device elements. The display may be an LCD screen including a touch screen.

Although the communication station 500 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 500 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 500 may include one or more processors and may be configured with instructions stored on a computer-readable storage device.

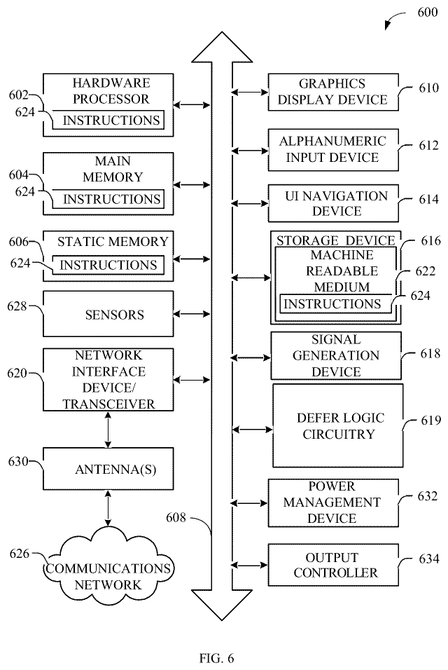

FIG. 6 illustrates a block diagram of an example of a machine 600 or system upon which any one or more of the techniques (e.g., methodologies) discussed herein may be performed. For instance, the machine may comprise an AP MLD such as the AP MLD 1005 and/or one of the user devices 1020 shown in FIG. 1A. In other embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a non-AP MLD or an AP MLD in network environments. The machine 600 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as link management. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via one or more interlinks (e.g., buses or high-speed interconnects) 608. Note that the single set of interlinks 608 may be representative of the physical interlinks in some embodiments but is not representative of the physical interlinks 608 in other embodiments. For example, the main memory 604 may couple directly with the hardware processor 602 via high-speed interconnects or a main memory bus. The high-speed interconnects typically connect two devices, and the bus is generally designed to interconnect two or more devices and include an arbitration scheme to provide fair access to the bus by the two or more devices.

The machine 600 may further include a power management device 632, a graphics display device 610, an alphanumeric input device 612 (e.g., a keyboard), and a user interface (UI) navigation device 614 (e.g., a mouse). In an example, the graphics display device 610, alphanumeric input device 612, and UI navigation device 614 may be a touch screen display. The machine 600 may additionally include a storage device (i.e., drive unit) 616, a signal generation device 618 (e.g., a speaker), a defer logic circuitry 619, a network interface device/transceiver 620 coupled to antenna(s) 630, and one or more sensors 628, such as a global positioning system (GPS) sensor, a compass, an accelerometer, or other sensor. The machine 600 may include an output controller 634, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor such as the baseband processing circuitry 1218 and/or 1248 shown in FIG. 1C. The baseband processor may be configured to generate corresponding baseband signals. The baseband processor may further include physical layer (PHY) and medium access control layer (MAC) circuitry and may further interface with the hardware processor 602 for generation and processing of the baseband signals and for controlling operations of the main memory 604, the storage device 616, and/or the defer logic circuitry 619. The baseband processor may be provided on a single radio card, a single chip, or an integrated circuit (IC).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within the static memory 606, or within the hardware processor 602 during execution thereof by the machine 600. In an example, one or any combination of the hardware processor 602, the main memory 604, the static memory 606, or the storage device 616 may constitute machine-readable media.

The defer logic circuitry 619 may carry out or perform any of the operations and processes in relation to secure sensing (e.g., flowchart of process 4000 shown in FIG. 4A and flowchart of process 4100 shown in FIG. 4B) described and shown herein. It is understood that the above are only a subset of what the defer logic circuitry 619 may be configured to perform and that other functions included throughout this disclosure may also be performed by the defer logic circuitry 619.

While the machine-readable medium 622 is illustrated as a single medium, the term “machine-readable medium” may include a single medium or multiple media (e.g., a centralized or distributed database, and/or associated caches and servers) configured to store the one or more instructions 624.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 600 and that cause the machine 600 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device/transceiver 620 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 620 may include one or more physical jacks (e.g., Ethernet, coaxial, or phone jacks) or one or more antennas to connect to the communications network 626. In an example, the network interface device/transceiver 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 600 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

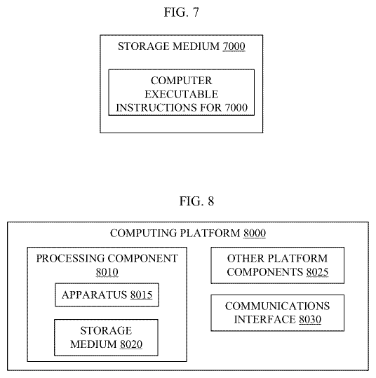

FIG. 7 illustrates an example of a storage medium 7000 to store association logic such as logic to implement the defer logic circuitry 619 shown in FIG. 6 and/or the other logic discussed herein for secure sensing. Storage medium 7000 may comprise an article of manufacture. In some examples, storage medium 7000 may include any non-transitory computer readable medium or machine-readable medium, such as an optical, magnetic or semiconductor storage. Storage medium 7000 may store diverse types of computer executable instructions, such as instructions to implement logic flows and/or techniques described herein. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like.

FIG. 8 illustrates an example computing platform 8000 such as the MLD STAs 1210, 1230, 1290, 1292, 1294, 1296, and 1298 in FIG. 1C. In some examples, as shown in FIG. 8, computing platform 8000 may include a processing component 8010, other platform components or a communications interface 8030 such as the wireless network interfaces 1222 and 1252 shown in FIG. 1C. According to some examples, computing platform 8000 may be a computing device such as a server in a system such as a data center or server farm that supports a manager or controller for managing configurable computing resources as mentioned above. In some embodiments, the computing platform may comprise a mobile device such as a smart phone, a tablet, a notebook, a laptop, a headset, a power amplifier, a television, a speaker, a video/audio streaming device, a stereo, and/or the like.

According to some examples, processing component 8010 may execute processing operations or logic for apparatus 8015 described herein. Processing component 8010 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits (ICs), application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements, which may reside in the storage medium 8020, may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. While discussions herein describe elements of embodiments as software elements and/or hardware elements, decisions to implement an embodiment using hardware elements and/or software elements may vary in accordance with any number of design considerations or factors, such as desired computational rate, power levels, heat tolerances, processing cycle budget, input data rates, output data rates, memory resources, data bus speeds and other design or performance constraints.

In some examples, other platform components 8025 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., universal serial bus (USB) memory), solid state drives (SSD) and any other type of storage media suitable for storing information.

In some examples, communications interface 8030 may include logic and/or features to support a communication interface. For these examples, communications interface 8030 may include one or more communication interfaces that operate according to various communication protocols or standards to communicate over direct or network communication links. Direct communications may occur via use of communication protocols or standards described in one or more industry standards (including progenies and variants) such as those associated with the Peripheral Component Interconnect (PCI) Express specification. Network communications may occur via use of communication protocols or standards such as those described in one or more Ethernet standards promulgated by the Institute of Electrical and Electronics Engineers (IEEE). For example, one such Ethernet standard may include IEEE 802.3-2012, Carrier sense Multiple access with Collision Detection (CSMA/CD) Access Method and Physical Layer Specifications, Published in December 2012 (hereinafter “IEEE 802.3”). Network communication may also occur according to one or more OpenFlow specifications such as the OpenFlow Hardware Abstraction API Specification. Network communications may also occur according to Infiniband Architecture Specification, Volume 1, Release 1.3, published in March 2015 (“the Infiniband Architecture specification”).

Computing platform 8000 may be part of a computing device that may be, for example, a server, a server array or server farm, a web server, a network server, an Internet server, a workstation, a mini-computer, a main frame computer, a supercomputer, a network appliance, a web appliance, a distributed computing system, multiprocessor systems, processor-based systems, or combination thereof. Accordingly, various embodiments of the computing platform 8000 may include or exclude functions and/or specific configurations of the computing platform 8000 described herein.

The components and features of computing platform 8000 may comprise any combination of discrete circuitry, ASICs, logic gates and/or single chip architectures. Further, the features of computing platform 8000 may comprise microcontrollers, programmable logic arrays and/or microprocessors or any combination of the foregoing where suitably appropriate. Note that hardware, firmware and/or software elements may be collectively or individually referred to herein as “logic”.

One or more aspects of at least one example may comprise representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that make the logic or processor.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

Advantages of Some Embodiments

Several embodiments have one or more potentially advantages effects. For instance, defer logic circuitry may, advantageously increase chances that there is a contention period close to the start of the rTWT SP and improve the likelihood that the AP will grab the medium to schedule the urgent traffic within the rTWT SP. The defer logic circuitry may, advantageously improve predicted latency in prioritized access. Furthermore, the defer logic circuitry may, advantageously fix a gap that may otherwise cause the AP or the rTWT members to fail to gain the medium during this contention period at the beginning of rTWT SPs.

### EXAMPLES OF FURTHER EMBODIMENTS

The following examples pertain to further embodiments. Specifics in the examples may be used anywhere in one or more embodiments.

Example 1 is an apparatus comprising a memory; and logic circuitry coupled with the memory to cause transmission of a defer signal in a contention period that is concurrent with a start of a restricted target wake time service period (rTWT SP), the apparatus comprising at least part of a first station (STA), wherein the first STA has an existing agreement with a second STA for the rTWT SP, at least one of the first STA and the second STA to comprise data associated with a predictable latency access category (AC_PL) of an enhanced distributed channel access (EDCA) mechanism; and contend for access to a medium for transmission of the data during the contention window. In Example 2, the apparatus of Example 1, the logic circuitry comprising baseband processing circuitry and further comprising a radio coupled with the baseband processing circuitry, and one or more antennas coupled with the radio to cause transmission of the data. In Example 3, the apparatus of Example 1, the contention period to start a margin time prior to the start of the rTWT SP. In Example 4, the apparatus of Example 1, the logic circuitry of the first STA to wait an interframe space (IFS) after the start of the contention period, prior to causing the transmission of the defer signal, wherein the IFS comprises a priority interframe space (PIFS) or a distributed channel access interframe space (DIFS). In Example 5, the apparatus of Example 1, wherein the first STA comprises an access point (AP) STA, the rTWT SP comprises a trigger-enabled rTWT SP, and the second STA comprises a member STA of the rTWT SP, wherein member STAs of the rTWT are not allowed to transmit a defer signal in the contention period that is concurrent with the start of the rTWT. In Example 6, the apparatus of Example 1, wherein the first STA comprises an access point (AP) STA, the rTWT SP comprises a trigger-enabled rTWT SP, and the second STA comprises a member STA of the rTWT SP, wherein member STAs of the rTWT SP are allowed to transmit a defer signal in the contention period that is concurrent with the start of the rTWT SP, the second STA to cause transmission of the defer signal concurrently with the defer signal of the first STA. In Example 7, the apparatus of Example 6, the existing agreement to identify a mode of the trigger-enabled rTWT SP as a first mode, the first mode associated with a rule to prevent the second STA from contending for access during the contention period of the trigger-enabled rTWT SP. In Example 8, the apparatus of Example 7, a target wake time (TWT) parameters element of a TWT response frame or a TWT request frame to comprise a mode field, the mode field to indicate the mode of the existing agreement. In Example 9, the apparatus of Example 1, wherein the first STA comprises a non-access point (non-AP) STA that is a member of the rTWT SP, the rTWT SP comprises a trigger-enabled rTWT SP, and the second STA comprises an access point (AP) STA of the rTWT SP, wherein member STAs of the rTWT SP and the AP STA of the rTWT SP are allowed to transmit a defer signal in the contention period that is concurrent with the start of the rTWT SP, the second STA to cause transmission of the defer signal concurrently with the defer signal of the first STA, the existing agreement to identify a mode of the trigger-enabled rTWT SP as a second mode, the second mode associated with a rule to prevent the AP STA from contending for access during the contention period of the trigger-enabled rTWT SP. In Example 10, the apparatus of Example 1, wherein the first STA comprises a non-access point (non-AP) STA that is a member of the rTWT SP, wherein the rTWT SP comprises a non-trigger-enabled rTWT SP, wherein member STAs of the rTWT SP are allowed to transmit a defer signal in the contention period that is concurrent with the start of the rTWT SP.

Example 11 is a non-transitory computer-readable medium, comprising instructions, which when executed by a processor, cause the processor to perform operations to cause transmission of a defer signal in a contention period that is concurrent with a start of a restricted target wake time service period (rTWT SP), the apparatus comprising at least part of a first station (STA), wherein the first STA has an existing agreement with a second STA for the rTWT SP, at least one of the first STA and the second STA to comprise data associated with a predictable latency access category (AC_PL) of an enhanced distributed channel access (EDCA) mechanism; and contend for access to a medium for transmission of the data during the contention window. In Example 12, the non-transitory computer-readable medium of Example 11, wherein the first STA waits an interframe space (IFS) after the start of the contention period, prior to causing the transmission of the defer signal, wherein the IFS comprises a priority interframe space (PIFS) or a distributed channel access interframe space (DIFS). In Example 13, the non-transitory computer-readable medium of Example 11, wherein the first STA comprises an access point (AP) STA, the rTWT SP comprises a trigger-enabled rTWT SP, and the second STA comprises a member STA of the rTWT SP, wherein member STAs of the rTWT SP are allowed to transmit a defer signal in the contention period that is concurrent with the start of the rTWT SP, the second STA to cause transmission of the defer signal concurrently with the defer signal of the first STA. In Example 14, the non-transitory computer-readable medium of Example 11, wherein the first STA comprises a non-access point (non-AP) STA that is a member of the rTWT SP, wherein the rTWT SP comprises a non-trigger-enabled rTWT SP, wherein member STAs of the rTWT SP are allowed to transmit a defer signal in the contention period that is concurrent with the start of the rTWT SP.

Example 15 is a method comprising causing transmission of a defer signal in a contention period that is concurrent with a start of a restricted target wake time service period (rTWT SP), the apparatus comprising at least part of a first station (STA), wherein the first STA has an existing agreement with a second STA for the rTWT SP, at least one of the first STA and the second STA to comprise data associated with a predictable latency access category (AC_PL) of an enhanced distributed channel access (EDCA) mechanism; and contending for access to a medium for transmission of the data during the contention window. In Example 16, the method of Example 15, the contention period to start a margin time prior to the start of the rTWT SP. In Example 17, the method of Example 15, further comprising waiting an interframe space (IFS) after the start of the contention period, prior to causing the transmission of the defer signal, wherein the IFS comprises a priority interframe space (PIFS) or a distributed channel access interframe space (DIFS). In Example 18, the method of Example 15, wherein the first STA comprises an access point (AP) STA, the rTWT SP comprises a trigger-enabled rTWT SP, and the second STA comprises a member STA of the rTWT SP, wherein member STAs of the rTWT are not allowed to transmit a defer signal in the contention period that is concurrent with the start of the rTWT. In Example 19, the method of Example 15, wherein the first STA comprises an access point (AP) STA, the rTWT SP comprises a trigger-enabled rTWT SP, and the second STA comprises a member STA of the rTWT SP, wherein member STAs of the rTWT SP are allowed to transmit a defer signal in the contention period that is concurrent with the start of the rTWT SP, the second STA to cause transmission of the defer signal concurrently with the defer signal of the first STA. In Example 20, the method of Example 15, wherein the first STA comprises a non-access point (non-AP) STA that is a member of the rTWT SP, wherein the rTWT SP comprises a non-trigger-enabled rTWT SP, wherein member STAs of the rTWT SP are allowed to transmit a defer signal in the contention period that is concurrent with the start of the rTWT SP.

Example 21 is a method to perform the actions described in any one of claims 1-20.

Example 22 is an apparatus comprising means for performing the method of claim 21.

What is claimed is:

1. An apparatus comprising:
a memory; and
logic circuitry coupled with the memory to:
cause transmission of a defer signal in a contention period that is concurrent with a start of a restricted target wake time service period (rTWT SP), the apparatus comprising at least part of a first station (STA), wherein the first STA has an existing agreement with a second STA for the rTWT SP, at least one of the first STA and the second STA to comprise data associated with a predictable latency access category (AC_PL) of an enhanced distributed channel access (EDCA) mechanism; and
contend for access to a medium for transmission of the data during the contention window.

2. The apparatus of claim 1, the logic circuitry comprising baseband processing circuitry and further comprising a radio coupled with the baseband processing circuitry, and one or more antennas coupled with the radio to cause transmission of the data.

3. The apparatus of claim 1, the contention period to start a margin time prior to the start of the rTWT SP.

4. The apparatus of claim 1, the logic circuitry of the first STA to wait an interframe space (IFS) after the start of the contention period, prior to causing the transmission of the defer signal, wherein the IFS comprises a priority interframe space (PIFS) or a distributed channel access interframe space (DIFS).

5. The apparatus of claim 1, wherein the first STA comprises an access point (AP) STA, the rTWT SP comprises a trigger-enabled rTWT SP, and the second STA comprises a member STA of the rTWT SP, wherein member STAs of the rTWT are not allowed to transmit a defer signal in the contention period that is concurrent with the start of the rTWT.

6. The apparatus of claim 1, wherein the first STA comprises an access point (AP) STA, the rTWT SP comprises a trigger-enabled rTWT SP, and the second STA comprises a member STA of the rTWT SP, wherein member STAs of the rTWT SP are allowed to transmit a defer signal in the contention period that is concurrent with the start of the rTWT SP, the second STA to cause transmission of the defer signal concurrently with the defer signal of the first STA.

7. The apparatus of claim 6, the existing agreement to identify a mode of the trigger-enabled rTWT SP as a first mode, the first mode associated with a rule to prevent the second STA from contending for access during the contention period of the trigger-enabled rTWT SP.

8. The apparatus of claim 7, a target wake time (TWT) parameters element of a TWT response frame or a TWT request frame to comprise a mode field, the mode field to indicate the mode of the existing agreement.

9. The apparatus of claim 1, wherein the first STA comprises a non-access point (non-AP) STA that is a member of the rTWT SP, the rTWT SP comprises a trigger-enabled rTWT SP, and the second STA comprises an access point (AP) STA of the rTWT SP, wherein member STAs of the rTWT SP and the AP STA of the rTWT SP are allowed to transmit a defer signal in the contention period that is concurrent with the start of the rTWT SP, the second STA to cause transmission of the defer signal concurrently with the defer signal of the first STA, the existing agreement to identify a mode of the trigger-enabled rTWT SP as a second mode, the second mode associated with a rule to prevent the AP STA from contending for access during the contention period of the trigger-enabled rTWT SP.

10. The apparatus of claim 1, wherein the first STA comprises a non-access point (non-AP) STA that is a member of the rTWT SP, wherein the rTWT SP comprises a non-trigger-enabled rTWT SP, wherein member STAs of the rTWT SP are allowed to transmit a defer signal in the contention period that is concurrent with the start of the rTWT SP.

11. A non-transitory computer-readable medium, comprising instructions, which when executed by a processor, cause the processor to perform operations to:
cause transmission of a defer signal in a contention period that is concurrent with a start of a restricted target wake time service period (rTWT SP), the apparatus comprising at least part of a first station (STA), wherein the first STA has an existing agreement with a second STA for the rTWT SP, at least one of the first STA and the second STA to comprise data associated with a predictable latency access category (AC_PL) of an enhanced distributed channel access (EDCA) mechanism; and
contend for access to a medium for transmission of the data during the contention window.

12. The non-transitory computer-readable medium of claim 11, wherein the first STA waits an interframe space (IFS) after the start of the contention period, prior to causing the transmission of the defer signal, wherein the IFS comprises a priority interframe space (PIFS) or a distributed channel access interframe space (DIFS).

13. The non-transitory computer-readable medium of claim 11, wherein the first STA comprises an access point (AP) STA, the rTWT SP comprises a trigger-enabled rTWT SP, and the second STA comprises a member STA of the rTWT SP, wherein member STAs of the rTWT SP are allowed to transmit a defer signal in the contention period that is concurrent with the start of the rTWT SP, the second STA to cause transmission of the defer signal concurrently with the defer signal of the first STA.

14. The non-transitory computer-readable medium of claim 11, wherein the first STA comprises a non-access point (non-AP) STA that is a member of the rTWT SP, wherein the rTWT SP comprises a non-trigger-enabled rTWT SP, wherein member STAs of the rTWT SP are allowed to transmit a defer signal in the contention period that is concurrent with the start of the rTWT SP.

15. A method comprising:
causing transmission of a defer signal in a contention period that is concurrent with a start of a restricted target wake time service period (rTWT SP), the apparatus comprising at least part of a first station (STA), wherein the first STA has an existing agreement with a second STA for the rTWT SP, at least one of the first STA and the second STA to comprise data associated with a predictable latency access category (AC_PL) of an enhanced distributed channel access (EDCA) mechanism; and
contending for access to a medium for transmission of the data during the contention window.

16. The method of claim 15, the contention period to start a margin time prior to the start of the rTWT SP.

17. The method of claim 15, further comprising waiting an interframe space (IFS) after the start of the contention period, prior to causing the transmission of the defer signal, wherein the IFS comprises a priority interframe space (PIFS) or a distributed channel access interframe space (DIFS).

18. The method of claim 15, wherein the first STA comprises an access point (AP) STA, the rTWT SP comprises a trigger-enabled rTWT SP, and the second STA comprises a member STA of the rTWT SP, wherein member STAs of the rTWT are not allowed to transmit a defer signal in the contention period that is concurrent with the start of the rTWT.

19. The method of claim 15, wherein the first STA comprises an access point (AP) STA, the rTWT SP comprises a trigger-enabled rTWT SP, and the second STA comprises a member STA of the rTWT SP, wherein member STAs of the rTWT SP are allowed to transmit a defer signal in the contention period that is concurrent with the start of the rTWT SP, the second STA to cause transmission of the defer signal concurrently with the defer signal of the first STA.

20. The method of claim 15, wherein the first STA comprises a non-access point (non-AP) STA that is a member of the rTWT SP, wherein the rTWT SP comprises a non-trigger-enabled rTWT SP, wherein member STAs of the rTWT SP are allowed to transmit a defer signal in the contention period that is concurrent with the start of the rTWT SP.
